(19) United States
(12) Patent Application Publication
(10) Pub. No.: US 2026/0032282 A1
(43) Pub. Date: Jan. 29, 2026

(54) VIDEO CODING METHOD AND DEVICE USING LUMA COMPONENT-BASED CHROMA COMPONENT PREDICTION

(71) Applicants: HYUNDAI MOTOR COMPANY, Seoul (KR); KIA CORPORATION, Seoul (KR); KWANGWOON UNIVERSITY INDUSTRY-ACADEMIC COLLABORATION FOUNDATION, Seoul (KR)

(72) Inventors: Dong Gyu Sim, Seoul (KR); Min Hun Lee, Uijeongbu-si (KR); Joo Hyung Byeon, Seoul (KR); Jin Heo, Yongin-si (KR); Seung Wook Park, Yongin-si (KR)

(73) Assignees: HYUNDAI MOTOR COMPANY, Seoul (KR); KIA CORPORATION, Seoul (KR); KWANGWOON UNIVERSITY INDUSTRY-ACADEMIC COLLABORATION FOUNDATION, Seoul (KR)

(21) Appl. No.: 18/998,435

(22) PCT Filed: Jun. 28, 2023
(86) PCT No.: PCT/KR2023/009038

§ 371 Date: Jan. 24, 2025

(30) Foreign Application Priority Data
Aug. 9, 2022 (KR) 10-2022-0099336
Jun. 27, 2023 (KR) 10-2023-0082623

(51) Int. Cl. H04N 19/593; H04N 19/176; H04N 19/186

(52) U.S. Cl. CPC H04N 19/593; H04N 19/176; H04N 19/186

(57) ABSTRACT

A method and an apparatus are disclosed for video coding using luma component-based chroma component prediction. In the disclosed embodiments, a video decoding device derives a corresponding luma block to the current chroma block based on a color format. The video decoding device derives a reconstructed region of a luma component for the corresponding luma block and derives a reconstructed region of a chroma component for the current chroma block based on a block partitioning structure of the luma component and the chroma component and prediction information of the corresponding luma block. The video decoding device models a relationship between samples in the reconstructed region of the luma component and samples in the reconstructed region of the chroma component, and generates a prediction block of the current chroma block from samples in the corresponding luma block by using the modeled relationship.

### TECHNICAL FIELD

The present disclosure relates to a video coding method and an apparatus using luma component-based chroma component prediction.

### BACKGROUND

The statements in this section merely provide background information related to the present disclosure and do not necessarily constitute prior art.

Since video data has a large amount of data compared to audio or still image data, the video data requires a lot of hardware resources, including a memory, to store or transmit the video data without processing for compression.

Accordingly, an encoder is generally used to compress and store or transmit video data. A decoder receives the compressed video data, decompresses the received compressed video data, and plays the decompressed video data. Video compression techniques include H.264/Advanced Video Coding (AVC), High Efficiency Video Coding (HEVC), and Versatile Video Coding (VVC), which has improved coding efficiency by about 30% or more compared to HEVC.

However, since the image size, resolution, and frame rate gradually increase, the amount of data to be encoded also increases. Accordingly, a new compression technique providing higher coding efficiency and an improved image enhancement effect than existing compression techniques is required.

In VVC, intra prediction of chroma components can be performed based on planar, DC, horizontal, vertical modes, direct mode (DM), or cross-component linear model (CCLM) mode. The DM predicts the current chroma block by using the prediction mode used in the prediction process of the luma block corresponding to the current chroma block. The CCLM mode is a new prediction mode adopted and added to VVC, which linearly models the relationship between the reconstructed adjacent sample values of the current chroma block and corresponding luma block's (at the position corresponding to the current chroma block) reconstructed adjacent sample values. Using the derived linear model, the CCLM mode transforms the values in the reconstructed region of the corresponding luma block to predict the current chroma component. The CCLM mode includes three modes, each of which can derive a linear model by using samples in the reconstructed region at the top of the current block, the top-and-left of the current block, or the left of the current block. To indicate one of the three modes, the encoder may signal a relevant index to the decoder.

In the intra prediction of the chroma component as described above, the reconstructed adjacent samples of the current chroma block and/or the corresponding luma block are utilized. Therefore, to increase video coding efficiency and enhance video quality, efficient utilization of neighboring reconstructed samples of the current chroma block and/or the corresponding luma block needs to be considered.

### DISCLOSURE

### Technical Problem

The present disclosure seeks to provide a video coding method and an apparatus which, when predicting a chroma component after prediction and reconstruction of a luma component for a current block, reconstruct a current chroma block by using prediction information of a corresponding luma block at a position corresponding to the current chroma block, the corresponding luma block's reconstructed sample values, and the current chroma block's neighboring reconstructed sample values.

### Technical Solution

At least one aspect of the present disclosure provides a method performed by a video decoding device for intra predicting a current chroma block. The method includes deriving a corresponding luma block that corresponds to the current chroma block based on a color format that represents a corresponding relation between pixels of the corresponding luma block and pixels of the current chroma block. The method also includes deriving a reconstructed region of a luma component for the corresponding luma block and deriving a reconstructed region of a chroma component for the current chroma block based on a block partitioning structure of the luma component and the chroma component and prediction information of the corresponding luma block, The method also includes modeling a relationship between samples in the reconstructed region of the luma component and samples in the reconstructed region of the chroma component. The method also includes generating a prediction block of the current chroma block from samples in the corresponding luma block by using a modeled relationship.

Another aspect of the present disclosure provides a method performed by a video encoding device for intra predicting a current chroma block. The method includes deriving a corresponding luma block that corresponds to the current chroma block based on a color format that represents a corresponding relation between pixels of the corresponding luma block and pixels of the current chroma block. The method also includes deriving a reconstructed region of a luma component for the corresponding luma block and deriving a reconstructed region of a chroma component for the current chroma block based on a block partitioning structure of the luma component and the chroma component and prediction information of the corresponding luma block. The method also includes modeling a relationship between samples in the reconstructed region of the luma component and samples in the reconstructed region of the chroma component. The method also includes generating a first prediction block of the current chroma block from samples in the corresponding luma block by using a modeled relationship.

Yet another aspect of the present disclosure provides a computer-readable recording medium storing a bitstream generated by a video encoding method. The video encoding method includes deriving a corresponding luma block that corresponds to a current chroma block based on a color format that represents a corresponding relation between pixels of the corresponding luma block and pixels of the current chroma block. The video encoding method also includes deriving a reconstructed region of a luma component for the corresponding luma block and deriving a reconstructed region of a chroma component for the current chroma block based on a block partitioning structure of the luma component and the chroma component and prediction information of the corresponding luma block. The video encoding method also includes modeling a relationship between samples in the reconstructed region of the luma component and samples in the reconstructed region of the chroma component. The video encoding method also includes generating a prediction block of the current chroma block from samples in the corresponding luma block by using a modeled relationship.

### Advantageous Effects

As described above, the present disclosure provides a video coding method and an apparatus that reconstruct a current chroma block by using prediction information of a corresponding luma block corresponding to the current chroma block, the corresponding luma block's reconstructed sample values, and the current chroma block's neighboring reconstructed sample values. Thus, the video coding method and the apparatus increase video coding efficiency and enhance video quality.

### BRIEF DESCRIPTION OF THE DRAWINGS

FIG. 1 is a block diagram of a video encoding apparatus that may implement the techniques of the present disclosure.

FIG. 2 illustrates a method for partitioning a block using a quadtree plus binarytree ternarytree (QTBTTT) structure.

FIGS. 3A and 3B illustrate a plurality of intra prediction modes including wide-angle intra prediction modes.

FIG. 4 illustrates neighboring blocks of a current block.

FIG. 5 is a block diagram of a video decoding apparatus that may implement the techniques of the present disclosure.

FIG. 6 is a block diagram detailing a portion of a video decoding device, according to at least one embodiment of the present disclosure.

FIGS. 7A to 7C are diagrams illustrating the positions of samples used for modeling, according to at least one embodiment of the present disclosure.

FIG. 8 is a diagram illustrating a derivation of the positions of samples used for modeling, according to at least one embodiment of the present disclosure.

FIGS. 9A and 9B are diagrams illustrating the derivation of the positions of samples used for modeling, according to another embodiment of the present disclosure.

FIGS. 10 and 11 are diagrams illustrating the implicit derivation of positions of samples used for modeling, according to other embodiments of the present disclosure.

FIGS. 12A and 12B are diagrams illustrating the implicit derivation of positions of samples used for modeling, according to yet another embodiment of the present disclosure.

FIGS. 13A and 13B are diagrams illustrating the implicit derivation of positions of samples used for modeling, according to yet another embodiment of the present disclosure.

FIG. 14 is a diagram illustrating the derivation of a reconstructed reference line or region of a chroma component, according to at least one embodiment of the present disclosure.

FIGS. 15A and 15B are diagrams illustrating the implicit derivation of a reconstructed reference line or region of a chroma component, according to at least one embodiment of the present disclosure.

FIG. 16 is a diagram illustrating the implicit derivation of a reconstructed reference line or region of a chroma component, according to another embodiment of the present disclosure.

FIG. 17 is a flowchart of a method of intra predicting the current block performed by a video encoding device, according to at least one embodiment of the present disclosure.

FIG. 18 is a flowchart of a method of intra predicting the current block performed by a video decoding device, according to at least one embodiment of the present disclosure.

### DETAILED DESCRIPTION

Hereinafter, some embodiments of the present disclosure are described in detail with reference to the accompanying illustrative drawings. In the following description, like reference numerals designate like elements, although the elements are shown in different drawings. Further, in the following description of some embodiments, detailed descriptions of related known components and functions when considered to obscure the subject of the present disclosure may be omitted for the purpose of clarity and for brevity.

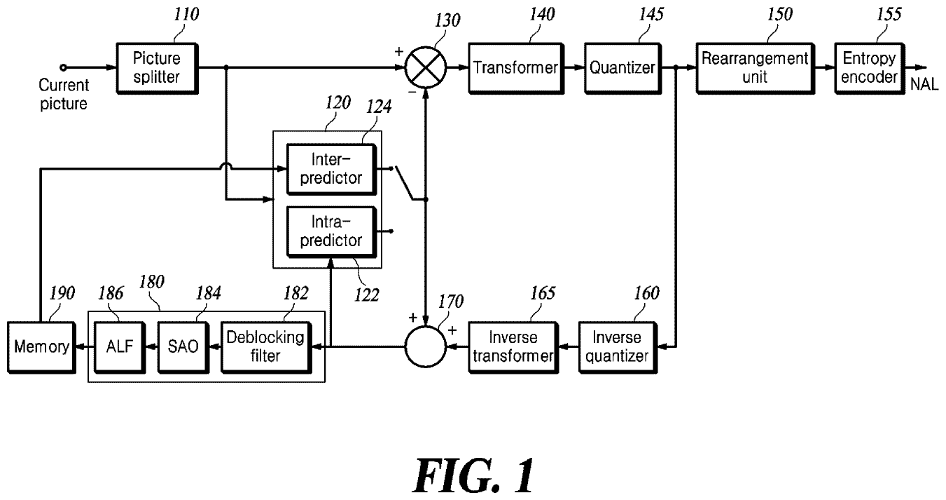

FIG. 1 is a block diagram of a video encoding apparatus that may implement technologies of the present disclosure. Hereinafter, referring to illustration of FIG. 1, the video encoding apparatus and components of the apparatus are described.

The encoding apparatus may include a picture splitter 110, a predictor 120, a subtractor 130, a transformer 140, a quantizer 145, a rearrangement unit 150, an entropy encoder 155, an inverse quantizer 160, an inverse transformer 165, an adder 170, a loop filter unit 180, and a memory 190.

Each component of the encoding apparatus may be implemented as hardware or software or implemented as a combination of hardware and software. Further, a function of each component may be implemented as software, and a microprocessor may also be implemented to execute the function of the software corresponding to each component.

One video is constituted by one or more sequences including a plurality of pictures. Each picture is split into a plurality of areas, and encoding is performed for each area. For example, one picture is split into one or more tiles or/and slices. Here, one or more tiles may be defined as a tile group. Each tile or/and slice is split into one or more coding tree units (CTUs). In addition, each CTU is split into one or more coding units (CUs) by a tree structure. Information applied to each coding unit (CU) is encoded as a syntax of the CU, and information commonly applied to the CUs included in one CTU is encoded as the syntax of the CTU. Further, information commonly applied to all blocks in one slice is encoded as the syntax of a slice header, and information applied to all blocks constituting one or more pictures is encoded to a picture parameter set (PPS) or a picture header. Furthermore, information, which the plurality of pictures commonly refers to, is encoded to a sequence parameter set (SPS). In addition, information, which one or more SPS commonly refer to, is encoded to a video parameter set (VPS). Further, information commonly applied to one tile or tile group may also be encoded as the syntax of a tile or tile group header. The syntaxes included in the SPS, the PPS, the slice header, the tile, or the tile group header may be referred to as a high level syntax.

The picture splitter 110 determines a size of a coding tree unit (CTU). Information on the size of the CTU (CTU size) is encoded as the syntax of the SPS or the PPS and delivered to a video decoding apparatus.

The picture splitter 110 splits each picture constituting the video into a plurality of coding tree units (CTUs) having a predetermined size and then recursively splits the CTU by using a tree structure. A leaf node in the tree structure becomes the coding unit (CU), which is a basic unit of encoding.

The tree structure may be a quadtree (QT) in which a higher node (or a parent node) is split into four lower nodes (or child nodes) having the same size. The tree structure may also be a binarytree (BT) in which the higher node is split into two lower nodes. The tree structure may also be a ternarytree (TT) in which the higher node is split into three lower nodes at a ratio of 1:2:1. The tree structure may also be a structure in which two or more structures among the QT structure, the BT structure, and the TT structure are mixed. For example, a quadtree plus binarytree (QTBT) structure may be used or a quadtree plus binarytree ternarytree (QTBTTT) structure may be used. Here, a binarytree ternarytree (BTTT) is added to the tree structures to be referred to as a multiple-type tree (MTT).

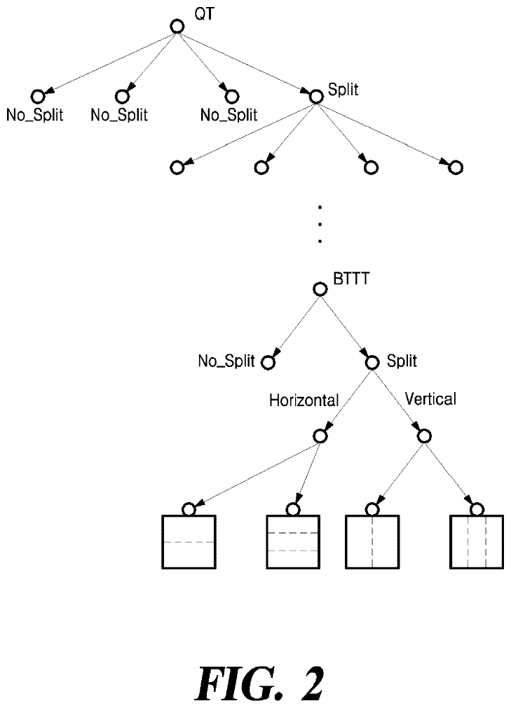

FIG. 2 is a diagram for describing a method for splitting a block by using a QTBTTT structure.

As illustrated in FIG. 2, the CTU may first be split into the QT structure. Quadtree splitting may be recursive until the size of a splitting block reaches a minimum block size (MinQTSize) of the leaf node permitted in the QT. A first flag (QT_split_flag) indicating whether each node of the QT structure is split into four nodes of a lower layer is encoded by the entropy encoder 155 and signaled to the video decoding apparatus. When the leaf node of the QT is not larger than a maximum block size (MaxBTSize) of a root node permitted in the BT, the leaf node may be further split into at least one of the BT structure or the TT structure. A plurality of split directions may be present in the BT structure and/or the TT structure. For example, there may be two directions, i.e., a direction in which the block of the corresponding node is split horizontally and a direction in which the block of the corresponding node is split vertically. As illustrated in FIG. 2, when the MTT splitting starts, a second flag (mtt_split_flag) indicating whether the nodes are split, and a flag additionally indicating the split direction (vertical or horizontal), and/or a flag indicating a split type (binary or ternary) if the nodes are split are encoded by the entropy encoder 155 and signaled to the video decoding apparatus.

Alternatively, prior to encoding the first flag (QT_split_flag) indicating whether each node is split into four nodes of the lower layer, a CU split flag (split_cu_flag) indicating whether the node is split may also be encoded. When a value of the CU split flag (split_cu_flag) indicates that each node is not split, the block of the corresponding node becomes the leaf node in the split tree structure and becomes the CU, which is the basic unit of encoding. When the value of the CU split flag (split_cu_flag) indicates that each node is split, the video encoding apparatus starts encoding the first flag first by the above-described scheme.

When the QTBT is used as another example of the tree structure, there may be two types, i.e., a type (i.e., symmetric horizontal splitting) in which the block of the corresponding node is horizontally split into two blocks having the same size and a type (i.e., symmetric vertical splitting) in which the block of the corresponding node is vertically split into two blocks having the same size. A split flag (split_flag) indicating whether each node of the BT structure is split into the block of the lower layer and split type information indicating a splitting type are encoded by the entropy encoder 155 and delivered to the video decoding apparatus. Meanwhile, a type in which the block of the corresponding node is split into two blocks asymmetrical to each other may be additionally present. The asymmetrical form may include a form in which the block of the corresponding node is split into two rectangular blocks having a size ratio of 1:3 or may also include a form in which the block of the corresponding node is split in a diagonal direction.

The CU may have various sizes according to QTBT or QTBTTT splitting from the CTU. Hereinafter, a block corresponding to a CU (i.e., the leaf node of the QTBTTT) to be encoded or decoded is referred to as a “current block.” As the QTBTTT splitting is adopted, a shape of the current block may also be a rectangular shape in addition to a square shape.

The predictor 120 predicts the current block to generate a prediction block. The predictor 120 includes an intra predictor 122 and an inter predictor 124.

In general, each of the current blocks in the picture may be predictively coded. In general, the prediction of the current block may be performed by using an intra prediction technology (using data from the picture including the current block) or an inter prediction technology (using data from a picture coded before the picture including the current block). The inter prediction includes both unidirectional prediction and bidirectional prediction.

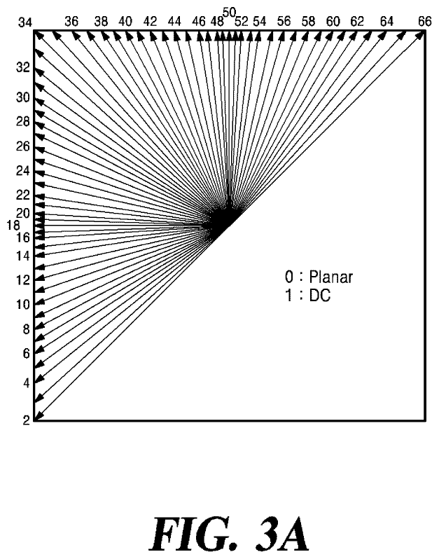

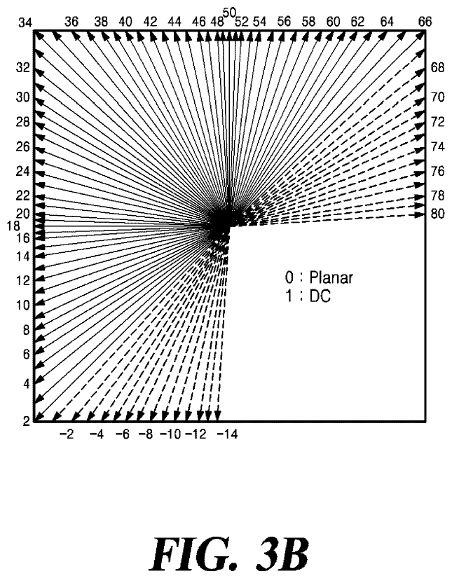

The intra predictor 122 predicts pixels in the current block by using pixels (reference pixels) positioned on a neighbor of the current block in the current picture including the current block. There is a plurality of intra prediction modes according to the prediction direction. For example, as illustrated in FIG. 3A, the plurality of intra prediction modes may include 2 non-directional modes including a Planar mode and a DC mode and may include 65 directional modes. A neighboring pixel and an arithmetic equation to be used are defined differently according to each prediction mode.

For efficient directional prediction for the current block having a rectangular shape, directional modes (#67 to #80, intra prediction modes #−1 to #−14) illustrated as dotted arrows in FIG. 3B may be additionally used. The directional modes may be referred to as “wide angle intra-prediction modes”. In FIG. 3B, the arrows indicate corresponding reference samples used for the prediction and do not represent the prediction directions. The prediction direction is opposite to a direction indicated by the arrow. When the current block has the rectangular shape, the wide angle intra-prediction modes are modes in which the prediction is performed in an opposite direction to a specific directional mode without additional bit transmission. In this case, among the wide angle intra-prediction modes, some wide angle intra-prediction modes usable for the current block may be determined by a ratio of a width and a height of the current block having the rectangular shape. For example, when the current block has a rectangular shape in which the height is smaller than the width, wide angle intra-prediction modes (intra prediction modes #67 to #80) having an angle smaller than 45 degrees are usable. When the current block has a rectangular shape in which the width is larger than the height, the wide angle intra-prediction modes having an angle larger than −135 degrees are usable.

The intra predictor 122 may determine an intra prediction to be used for encoding the current block. In some examples, the intra predictor 122 may encode the current block by using multiple intra prediction modes and may also select an appropriate intra prediction mode to be used from tested modes. For example, the intra predictor 122 may calculate rate-distortion values by using a rate-distortion analysis for multiple tested intra prediction modes and may also select an intra prediction mode having best rate-distortion features among the tested modes.

The intra predictor 122 selects one intra prediction mode among a plurality of intra prediction modes and predicts the current block by using a neighboring pixel (reference pixel) and an arithmetic equation determined according to the selected intra prediction mode. Information on the selected intra prediction mode is encoded by the entropy encoder 155 and delivered to the video decoding apparatus.

The inter predictor 124 generates the prediction block for the current block by using a motion compensation process. The inter predictor 124 searches a block most similar to the current block in a reference picture encoded and decoded earlier than the current picture and generates the prediction block for the current block by using the searched block. In addition, a motion vector (MV) is generated, which corresponds to a displacement between the current block in the current picture and the prediction block in the reference picture. In general, motion estimation is performed for a luma component, and a motion vector calculated based on the luma component is used for both the luma component and a chroma component. Motion information including information on the reference picture and information on the motion vector used for predicting the current block is encoded by the entropy encoder 155 and delivered to the video decoding apparatus.

The inter predictor 124 may also perform interpolation for the reference picture or a reference block in order to increase accuracy of the prediction. In other words, sub-samples between two contiguous integer samples are interpolated by applying filter coefficients to a plurality of contiguous integer samples including two integer samples. When a process of searching a block most similar to the current block is performed for the interpolated reference picture, not integer sample unit precision but decimal unit precision may be expressed for the motion vector. Precision or resolution of the motion vector may be set differently for each target area to be encoded, e.g., a unit such as the slice, the tile, the CTU, the CU, and the like. When such an adaptive motion vector resolution (AMVR) is applied, information on the motion vector resolution to be applied to each target area should be signaled for each target area. For example, when the target area is the CU, the information on the motion vector resolution applied for each CU is signaled. The information on the motion vector resolution may be information representing precision of a motion vector difference to be described below.

Meanwhile, the inter predictor 124 may perform inter prediction by using bi-prediction. In the case of bi-prediction, two reference pictures and two motion vectors representing a block position most similar to the current block in each reference picture are used. The inter predictor 124 selects a first reference picture and a second reference picture from reference picture list 0 (RefPicList0) and reference picture list 1 (RefPicList1), respectively. The inter predictor 124 also searches blocks most similar to the current blocks in the respective reference pictures to generate a first reference block and a second reference block. In addition, the prediction block for the current block is generated by averaging or weighted-averaging the first reference block and the second reference block. In addition, motion information including information on two reference pictures used for predicting the current block and including information on two motion vectors is delivered to the entropy encoder 155. Here, reference picture list 0 may be constituted by pictures before the current picture in a display order among pre-reconstructed pictures, and reference picture list 1 may be constituted by pictures after the current picture in the display order among the pre-reconstructed pictures. However, although not particularly limited thereto, the pre-reconstructed pictures after the current picture in the display order may be additionally included in reference picture list 0. Inversely, the pre-reconstructed pictures before the current picture may also be additionally included in reference picture list 1.

In order to minimize a bit quantity consumed for encoding the motion information, various methods may be used.

For example, when the reference picture and the motion vector of the current block are the same as the reference picture and the motion vector of the neighboring block, information capable of identifying the neighboring block is encoded to deliver the motion information of the current block to the video decoding apparatus. Such a method is referred to as a merge mode.

In the merge mode, the inter predictor 124 selects a predetermined number of merge candidate blocks (hereinafter, referred to as a “merge candidate”) from the neighboring blocks of the current block.

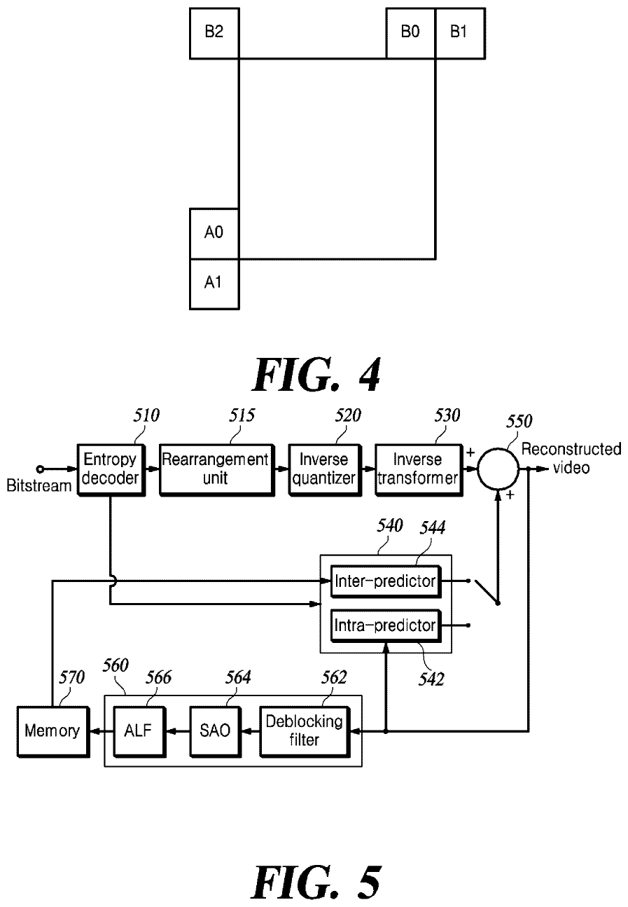

As a neighboring block for deriving the merge candidate, all or some of a left block A0, a bottom left block A1, a top block B0, a top right block B1, and a top left block B2 adjacent to the current block in the current picture may be used as illustrated in FIG. 4. Further, a block positioned within the reference picture (may be the same as or different from the reference picture used for predicting the current block) other than the current picture at which the current block is positioned may also be used as the merge candidate. For example, a co-located block with the current block within the reference picture or blocks adjacent to the co-located block may be additionally used as the merge candidate. If the number of merge candidates selected by the method described above is smaller than a preset number, a zero vector is added to the merge candidate.

The inter predictor 124 configures a merge list including a predetermined number of merge candidates by using the neighboring blocks. A merge candidate to be used as the motion information of the current block is selected from the merge candidates included in the merge list, and merge index information for identifying the selected candidate is generated. The generated merge index information is encoded by the entropy encoder 155 and delivered to the video decoding apparatus.

A merge skip mode is a special case of the merge mode. After quantization, when all transform coefficients for entropy encoding are close to zero, only the neighboring block selection information is transmitted without transmitting residual signals. By using the merge skip mode, it is possible to achieve a relatively high encoding efficiency for images with slight motion, still images, screen content images, and the like.

Hereafter, the merge mode and the merge skip mode are collectively referred to as the merge/skip mode.

Another method for encoding the motion information is an advanced motion vector prediction (AMVP) mode.

In the AMVP mode, the inter predictor 124 derives motion vector predictor candidates for the motion vector of the current block by using the neighboring blocks of the current block. As a neighboring block used for deriving the motion vector predictor candidates, all or some of a left block A0, a bottom left block A1, a top block B0, a top right block B1, and a top left block B2 adjacent to the current block in the current picture illustrated in FIG. 4 may be used. Further, a block positioned within the reference picture (may be the same as or different from the reference picture used for predicting the current block) other than the current picture at which the current block is positioned may also be used as the neighboring block used for deriving the motion vector predictor candidates. For example, a co-located block with the current block within the reference picture or blocks adjacent to the co-located block may be used. If the number of motion vector candidates selected by the method described above is smaller than a preset number, a zero vector is added to the motion vector candidate.

The inter predictor 124 derives the motion vector predictor candidates by using the motion vector of the neighboring blocks and determines motion vector predictor for the motion vector of the current block by using the motion vector predictor candidates. In addition, a motion vector difference is calculated by subtracting motion vector predictor from the motion vector of the current block.

The motion vector predictor may be acquired by applying a pre-defined function (e.g., center value and average value computation, and the like) to the motion vector predictor candidates. In this case, the video decoding apparatus also knows the pre-defined function. Further, since the neighboring block used for deriving the motion vector predictor candidate is a block in which encoding and decoding are already completed, the video decoding apparatus may also already know the motion vector of the neighboring block. Therefore, the video encoding apparatus does not need to encode information for identifying the motion vector predictor candidate. Accordingly, in this case, information on the motion vector difference and information on the reference picture used for predicting the current block are encoded.

Meanwhile, the motion vector predictor may also be determined by a scheme of selecting any one of the motion vector predictor candidates. In this case, information for identifying the selected motion vector predictor candidate is additional encoded jointly with the information on the motion vector difference and the information on the reference picture used for predicting the current block.

The subtractor 130 generates a residual block by subtracting the prediction block generated by the intra predictor 122 or the inter predictor 124 from the current block.

The transformer 140 transforms residual signals in a residual block having pixel values of a spatial domain into transform coefficients of a frequency domain. The transformer 140 may transform residual signals in the residual block by using a total size of the residual block as a transform unit or also split the residual block into a plurality of subblocks and may perform the transform by using the subblock as the transform unit. Alternatively, the residual block is divided into two subblocks, which are a transform area and a non-transform area, to transform the residual signals by using only the transform area subblock as the transform unit. Here, the transform area subblock may be one of two rectangular blocks having a size ratio of 1:1 based on a horizontal axis (or vertical axis). In this case, a flag (cu_sbt_flag) indicates that only the subblock is transformed, and directional (vertical/horizontal) information (cu_sbt_horizontal_flag) and/or positional information (cu_sbt_pos_flag) are encoded by the entropy encoder 155 and signaled to the video decoding apparatus. Further, a size of the transform area subblock may have a size ratio of 1:3 based on the horizontal axis (or vertical axis). In this case, a flag (cu_sbt_quad_flag) dividing the corresponding splitting is additionally encoded by the entropy encoder 155 and signaled to the video decoding apparatus.

Meanwhile, the transformer 140 may perform the transform for the residual block individually in a horizontal direction and a vertical direction. For the transform, various types of transform functions or transform matrices may be used. For example, a pair of transform functions for horizontal transform and vertical transform may be defined as a multiple transform set (MTS). The transformer 140 may select one transform function pair having highest transform efficiency in the MTS and may transform the residual block in each of the horizontal and vertical directions. Information (mts_idx) on the transform function pair in the MTS is encoded by the entropy encoder 155 and signaled to the video decoding apparatus.

The quantizer 145 quantizes the transform coefficients output from the transformer 140 using a quantization parameter and outputs the quantized transform coefficients to the entropy encoder 155. The quantizer 145 may also immediately quantize the related residual block without the transform for any block or frame. The quantizer 145 may also apply different quantization coefficients (scaling values) according to positions of the transform coefficients in the transform block. A quantization matrix applied to quantized transform coefficients arranged in 2 dimensional may be encoded and signaled to the video decoding apparatus.

The rearrangement unit 150 may perform realignment of coefficient values for quantized residual values.

The rearrangement unit 150 may change a 2D coefficient array to a 1D coefficient sequence by using coefficient scanning. For example, the rearrangement unit 150 may output the 1D coefficient sequence by scanning a DC coefficient to a high-frequency domain coefficient by using a zig-zag scan or a diagonal scan. According to the size of the transform unit and the intra prediction mode, vertical scan of scanning a 2D coefficient array in a column direction and horizontal scan of scanning a 2D block type coefficient in a row direction may also be used instead of the zig-zag scan. In other words, according to the size of the transform unit and the intra prediction mode, a scan method to be used may be determined among the zig-zag scan, the diagonal scan, the vertical scan, and the horizontal scan.

The entropy encoder 155 generates a bitstream by encoding a sequence of 1D quantized transform coefficients output from the rearrangement unit 150 by using various encoding schemes including a Context-based Adaptive Binary Arithmetic Code (CABAC), an Exponential Golomb, or the like.

Further, the entropy encoder 155 encodes information, such as a CTU size, a CTU split flag, a QT split flag, an MTT split type, an MTT split direction, etc., related to the block splitting to allow the video decoding apparatus to split the block equally to the video encoding apparatus. Further, the entropy encoder 155 encodes information on a prediction type indicating whether the current block is encoded by intra prediction or inter prediction. The entropy encoder 155 encodes intra prediction information (i.e., information on an intra prediction mode) or inter prediction information (in the case of the merge mode, a merge index and in the case of the AMVP mode, information on the reference picture index and the motion vector difference) according to the prediction type. Further, the entropy encoder 155 encodes information related to quantization, i.e., information on the quantization parameter and information on the quantization matrix.

The inverse quantizer 160 dequantizes the quantized transform coefficients output from the quantizer 145 to generate the transform coefficients. The inverse transformer 165 transforms the transform coefficients output from the inverse quantizer 160 into a spatial domain from a frequency domain to reconstruct the residual block.

The adder 170 adds the reconstructed residual block and the prediction block generated by the predictor 120 to reconstruct the current block. Pixels in the reconstructed current block may be used as reference pixels when intra-predicting a next-order block.

The loop filter unit 180 performs filtering for the reconstructed pixels in order to reduce blocking artifacts, ringing artifacts, blurring artifacts, etc., which occur due to block based prediction and transform/quantization. The loop filter unit 180 as an in-loop filter may include all or some of a deblocking filter 182, a sample adaptive offset (SAO) filter 184, and an adaptive loop filter (ALF) 186.

The deblocking filter 182 filters a boundary between the reconstructed blocks in order to remove a blocking artifact, which occurs due to block unit encoding/decoding, and the SAO filter 184 and the ALF 186 perform additional filtering for a deblocked filtered video. The SAO filter 184 and the ALF 186 are filters used for compensating differences between the reconstructed pixels and original pixels, which occur due to lossy coding. The SAO filter 184 applies an offset as a CTU unit to enhance a subjective image quality and encoding efficiency. On the other hand, the ALF 186 performs block unit filtering and compensates distortion by applying different filters by dividing a boundary of the corresponding block and a degree of a change amount. Information on filter coefficients to be used for the ALF may be encoded and signaled to the video decoding apparatus.

The reconstructed block filtered through the deblocking filter 182, the SAO filter 184, and the ALF 186 is stored in the memory 190. When all blocks in one picture are reconstructed, the reconstructed picture may be used as a reference picture for inter predicting a block within a picture to be encoded afterwards.

The video encoding device may store a bitstream of encoded video data in a non-transitory storage medium or transmit the bitstream to the video decoding device through a communication network.

FIG. 5 is a functional block diagram of a video decoding apparatus that may implement the technologies of the present disclosure. Hereinafter, referring to FIG. 5, the video decoding apparatus and components of the apparatus are described.

The video decoding apparatus may include an entropy decoder 510, a rearrangement unit 515, an inverse quantizer 520, an inverse transformer 530, a predictor 540, an adder 550, a loop filter unit 560, and a memory 570.

Similar to the video encoding apparatus of FIG. 1, each component of the video decoding apparatus may be implemented as hardware or software or implemented as a combination of hardware and software. Further, a function of each component may be implemented as the software, and a microprocessor may also be implemented to execute the function of the software corresponding to each component.

The entropy decoder 510 extracts information related to block splitting by decoding the bitstream generated by the video encoding apparatus to determine a current block to be decoded and extracts prediction information required for reconstructing the current block and information on the residual signals.

The entropy decoder 510 determines the size of the CTU by extracting information on the CTU size from a sequence parameter set (SPS) or a picture parameter set (PPS) and splits the picture into CTUs having the determined size. In addition, the CTU is determined as a highest layer of the tree structure, i.e., a root node, and split information for the CTU may be extracted to split the CTU by using the tree structure.

For example, when the CTU is split by using the QTBTTT structure, a first flag (QT_split_flag) related to splitting of the QT is first extracted to split each node into four nodes of the lower layer. In addition, a second flag (mtt_split_flag), a split direction (vertical/horizontal), and/or a split type (binary/ternary) related to splitting of the MTT are extracted with respect to the node corresponding to the leaf node of the QT to split the corresponding leaf node into an MTT structure. As a result, each of the nodes below the leaf node of the QT is recursively split into the BT or TT structure.

As another example, when the CTU is split by using the QTBTTT structure, a CU split flag (split_cu_flag) indicating whether the CU is split is extracted. When the corresponding block is split, the first flag (QT_split_flag) may also be extracted. During a splitting process, with respect to each node, recursive MTT splitting of 0 times or more may occur after recursive QT splitting of 0 times or more. For example, with respect to the CTU, the MTT splitting may immediately occur, or on the contrary, only QT splitting of multiple times may also occur.

As another example, when the CTU is split by using the QTBT structure, the first flag (QT_split_flag) related to the splitting of the QT is extracted to split each node into four nodes of the lower layer. In addition, a split flag (split_flag) indicating whether the node corresponding to the leaf node of the QT is further split into the BT, and split direction information are extracted.

Meanwhile, when the entropy decoder 510 determines a current block to be decoded by using the splitting of the tree structure, the entropy decoder 510 extracts information on a prediction type indicating whether the current block is intra predicted or inter predicted. When the prediction type information indicates the intra prediction, the entropy decoder 510 extracts a syntax element for intra prediction information (intra prediction mode) of the current block. When the prediction type information indicates the inter prediction, the entropy decoder 510 extracts information representing a syntax element for inter prediction information, i.e., a motion vector and a reference picture to which the motion vector refers.

Further, the entropy decoder 510 extracts quantization related information and extracts information on the quantized transform coefficients of the current block as the information on the residual signals.

The rearrangement unit 515 may change a sequence of 1D quantized transform coefficients entropy-decoded by the entropy decoder 510 to a 2D coefficient array (i.e., block) again in a reverse order to the coefficient scanning order performed by the video encoding apparatus.

The inverse quantizer 520 dequantizes the quantized transform coefficients and dequantizes the quantized transform coefficients by using the quantization parameter. The inverse quantizer 520 may also apply different quantization coefficients (scaling values) to the quantized transform coefficients arranged in 2D. The inverse quantizer 520 may perform dequantization by applying a matrix of the quantization coefficients (scaling values) from the video encoding apparatus to a 2D array of the quantized transform coefficients.

The inverse transformer 530 generates the residual block for the current block by reconstructing the residual signals by inversely transforming the dequantized transform coefficients into the spatial domain from the frequency domain.

Further, when the inverse transformer 530 inversely transforms a partial area (subblock) of the transform block, the inverse transformer 530 extracts a flag (cu_sbt_flag) that only the subblock of the transform block is transformed, directional (vertical/horizontal) information (cu_sbt_horizontal_flag) of the subblock, and/or positional information (cu_sbt_pos_flag) of the subblock. The inverse transformer 530 also inversely transforms the transform coefficients of the corresponding subblock into the spatial domain from the frequency domain to reconstruct the residual signals and fills an area, which is not inversely transformed, with a value of “0” as the residual signals to generate a final residual block for the current block.

Further, when the MTS is applied, the inverse transformer 530 determines the transform index or the transform matrix to be applied in each of the horizontal and vertical directions by using the MTS information (mts_idx) signaled from the video encoding apparatus. The inverse transformer 530 also performs inverse transform for the transform coefficients in the transform block in the horizontal and vertical directions by using the determined transform function.

The predictor 540 may include an intra predictor 542 and an inter predictor 544. The intra predictor 542 is activated when the prediction type of the current block is the intra prediction, and the inter predictor 544 is activated when the prediction type of the current block is the inter prediction.

The intra predictor 542 determines the intra prediction mode of the current block among the plurality of intra prediction modes from the syntax element for the intra prediction mode extracted from the entropy decoder 510. The intra predictor 542 also predicts the current block by using neighboring reference pixels of the current block according to the intra prediction mode.

The inter predictor 544 determines the motion vector of the current block and the reference picture to which the motion vector refers by using the syntax element for the inter prediction mode extracted from the entropy decoder 510.

The adder 550 reconstructs the current block by adding the residual block output from the inverse transformer 530 and the prediction block output from the inter predictor 544 or the intra predictor 542. Pixels within the reconstructed current block are used as a reference pixel upon intra predicting a block to be decoded afterwards.

The loop filter unit 560 as an in-loop filter may include a deblocking filter 562, an SAO filter 564, and an ALF 566. The deblocking filter 562 performs deblocking filtering a boundary between the reconstructed blocks in order to remove the blocking artifact, which occurs due to block unit decoding. The SAO filter 564 and the ALF 566 perform additional filtering for the reconstructed block after the deblocking filtering in order to compensate differences between the reconstructed pixels and original pixels, which occur due to lossy coding. The filter coefficients of the ALF are determined by using information on filter coefficients decoded from the bitstream.

The reconstructed block filtered through the deblocking filter 562, the SAO filter 564, and the ALF 566 is stored in the memory 570. When all blocks in one picture are reconstructed, the reconstructed picture may be used as a reference picture for inter predicting a block within a picture to be encoded afterwards.

The present disclosure in some embodiments relates to encoding and decoding video images as described above. More specifically, the present disclosure provides a video coding method and an apparatus for reconstructing a current chroma block by using prediction information of a luma block at a position corresponding to the current chroma block, reconstructed sample values of the luma block at the corresponding position, and neighboring reconstructed sample values of the current chroma block.

The following embodiments may be performed by the intra predictor 122 in the video encoding device. The following embodiments may also be performed by the intra predictor 542 in the video decoding device.

The video encoding device in encoding the current block may generate signaling information associated with the present embodiments in terms of optimizing rate distortion. The video encoding device may use the entropy encoder 155 to encode the signaling information and transmit the encoded signaling information to the video decoding device. The video decoding device may use the entropy decoder 510 to decode, from the bitstream, the signaling information associated with the decoding of the current block.

In the following description, the term “target block” may be used interchangeably with the current block or coding unit (CU), or may refer to some area of a coding unit.

Further, the value of one flag being true indicates when the flag is set to 1. Additionally, the value of one flag being false indicates when the flag is set to 0.

### I. Intra Prediction of Chroma Components

Several techniques are introduced to improve coding efficiency by using intra prediction.

In the VVC technique, the intra prediction modes of the luma block have 65 subdivided directional modes (i.e., 2 to 66) in addition to the non-directional modes (i.e., planar and DC), as illustrated in FIG. 3A. The 65 directional modes, planar and DC modes, are collectively referred to as 67 IPMs.

Depending on the prediction direction utilized by the luma block, the chroma block may also have limited access to intra prediction of these subdivided directional modes. However, the intra prediction of the chroma block may not always utilize the various directional modes available to the luma block except for the horizontal and vertical directions. To be able to use these different directional modes, the prediction mode of the current chroma block needs be set to DM (direct mode). By setting the prediction mode to DM, the current chroma block may utilize directional modes other than the horizontal and vertical modes of the luma block.

When a chroma block is encoded, the intra prediction modes that are most frequently used or defaulted to maintain video quality include planar, DC, vertical and horizontal modes, and DM. In DM, the intra prediction mode of the luma block that spatially corresponds to the current chroma block is used as the intra prediction mode of the chroma block.

The video encoding device may signal to the video decoding device whether the intra prediction mode of the chroma block is DM. The video encoding device may communicate the DM to the video decoding device in many ways. For example, the video encoding device may indicate whether the intra prediction mode of the chroma block is DM by setting intra_chroma_pred_mode, which is information for indicating the intra prediction mode of the chroma block, to a specific value and transmitting intra_chroma_pred_mode to the video decoding device.

When the chroma block is encoded in intra prediction mode, the video encoding device may set the intra prediction mode IntraPredModeC of the chroma block according to Table 1.

Hereinafter, to distinguish intra_chroma_pred_mode from IntraPredModeC, which are information related to the intra prediction mode of the chroma block, both are denoted as chroma intra prediction mode indicator and chroma intra prediction mode, respectively.

TABLE 1

| | | intra_{—} | lumaIntraPredMode | | | | |
|---|---|---|---|---|---|---|---|
| cclm_{—} | cclm_{—} | chroma_{—} | | | | | X |
| mode_{—} | mode_{—} | pred_{—} | | | | | (0 <= |
| flag | idx | mode | 0 | 50 | 18 | 1 | X <= 66) |
| 0 | — | 0 | 66 | 0 | 0 | 0 | 0 |
| 0 | — | 1 | 50 | 66 | 50 | 50 | 50 |
| 0 | — | 2 | 18 | 18 | 66 | 18 | 18 |
| 0 | — | 3 | 1 | 1 | 1 | 66 | 1 |
| 0 | — | 4 | 0 | 50 | 18 | 1 | X |
| 1 | 0 | — | 81 | 81 | 81 | 81 | 81 |
| 1 | 1 | — | 82 | 82 | 82 | 82 | 82 |
| 1 | 2 | — | 83 | 83 | 83 | 83 | 83 |

Here, lumaIntraPredMode is the intra prediction mode of the luma block corresponding to the current chroma block (hereinafter ‘luma intra prediction mode’). The lumaIntraPredMode represents one of the prediction modes illustrated in FIG. 3A. For example, in Table 1, lumaIntraPredMode=0 refers to the planar prediction mode and lumaIntraPredMode=1 refers to the DC prediction mode. Cases with lumaIntraPredMode of 18, 50, and 66 indicate directional modes referred to as horizontal, vertical, and VDIA, respectively. On the other hand, cases that intra_chroma_pred_mode=0, 1, 2, and 3 indicate planar, vertical, horizontal, and DC prediction modes, respectively. The case that intra_chroma_pred_mode=4 is DM, where the value of IntraPredModeC, the chroma intra prediction mode, is set equal to the value of lumaIntraPredMode.

Meanwhile, the process of parsing the intra prediction mode of the chroma block, performed by the video decoding device, is shown in Table 2.

TABLE 2

```
if( CclmEnabled )
  cclm_mode_flag
if( cclm_mode_flag )
  cclm_mode_idx
else
  intra_chroma_pred_mode
```

The video decoding device parses the cclm_mode_flag, which indicates whether to use cross-component linear model (CCLM) mode. If cclm_mode_flag is 1 to enable CCLM mode, the video decoding device parses cclm_mode_idx which indicates the CCLM mode. Depending on the value of cclm_mode_idx, the CCLM mode may indicate one of the three modes. On the other hand, if cclm_mode_flag is 0, indicating no use of CCLM mode, the video decoding device parses intra_chroma_pred_mode which indicates intra prediction mode, as described above.

If the CCLM mode is applied for intra prediction of the current chroma block, the video decoding device determines a corresponding region in the luma image corresponding to the current chroma block (hereinafter, the ‘corresponding luma region’). For prediction of the linear model, the left reference pixel and the top reference pixel of the corresponding luma region and the left reference pixel and the top reference pixel of the target chroma block may be utilized. Hereinafter, the left reference pixels and the top reference pixels are commonly referred to as reference pixels, neighboring pixels, or adjacent pixels. Additionally, reference pixels in the chroma channel are referred to as chroma reference pixels, and reference pixels in the luma channel are referred to as luma reference pixels.

In CCLM prediction, a prediction block that is a predictor of the target chroma block is generated by deriving a linear model between the reference pixels in the corresponding luma region and the reference pixels of the chroma block and then by applying the linear model to the reconstructed pixels in the corresponding luma region. For example, four pairs of pixels, which are pixels in the peripheral pixel line of the current chroma block and pixels in the corresponding luma region combined, may be used to derive the linear model. With respect to the four pairs of pixels, the video decoding device may derive a and R that represent the linear model, as shown in Equation 1.

$$α = \frac{{Y}_{b} - {Y}_{a}}{{X}_{b} - {X}_{a}} , \qquad [ Equation 1 ]$$

$$β = {Y}_{a} - α \cdot {X}_{a}$$

Here, Xₐ and X_{b} each represent the average value of the minimum and second smallest values, and the average value of the maximum and second largest values, of the corresponding luma pixels in the four pairs of pixels. Further, Yₐ and Yb each represent the average value of the minimum and the second smallest values, and the average value of the maximum and the second largest values, of the chroma pixels in the four pairs of pixels. Then, the video decoding device may use a linear model to generate a predictor pred_{C}(i,j) of the current chroma block from the pixel values rec′_{L}(i,j) of the corresponding luma region, as shown in Equation 2.

$${pred}_{C} ( i , j ) = α \cdot {rec}_{L}^{′} ( i , j ) + β \qquad [ Equation 2 ]$$

As described above, the CCLM mode is divided into three modes, CCLM_LT, CCLM_L, and CCLM_T, depending on the position of the neighboring pixels used in the derivation of the linear model. CCLM_LT mode uses two pixels in each direction from the neighboring pixels adjacent to the left side and top side of the current chroma block. CCLM_L mode uses four pixels from the neighboring pixels adjacent to the left of the current chroma block. Lastly, CCLM_T mode utilizes four pixels from the neighboring pixels adjacent to the top of the current chroma block.

The following embodiments are described with reference to the video decoding device but may be implemented identically or similarly in the video encoding device.

### II. Embodiments According to the Present Disclosure

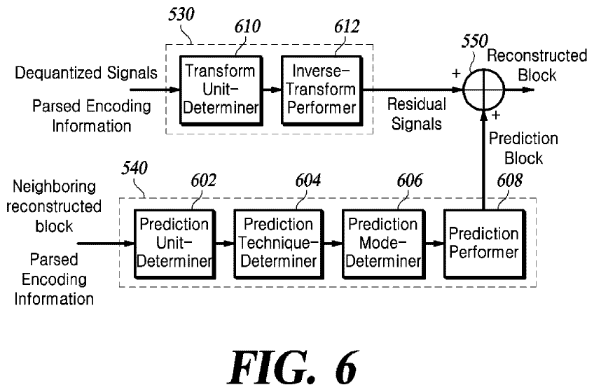

FIG. 6 is a block diagram detailing a portion of a video decoding device, according to at least one embodiment of the present disclosure.

The video decoding device according to some embodiments can determine prediction unit and transform unit, and for a current block corresponding to the determined unit, perform a prediction and an inverse transform by using a determined prediction technique and prediction mode, to finally generate a reconstructed block of the current block. The operations illustrated in FIG. 6 may be performed by an inverse transformer 530, a predictor 540, and an adder 550 of the video decoding device. On the other hand, the same operations as illustrated in FIG. 6 may be performed by the inverse transformer 165, the picture splitter 110, the predictor 120, and the adder 170 of the video encoding device. In this case, the video decoding device uses encoding information parsed from the bitstream, but the video encoding device may use encoding information set from a higher level in terms of minimizing rate distortion. Hereinafter, for convenience, the embodiments are described centering on the video decoding device.

As illustrated in FIG. 5, the predictor 540 includes the intra predictor 542 and the inter predictor 544, depending on the prediction technique, but as illustrated in FIG. 6, the predictor 540 may include all or part of a prediction unit-determiner 602, a prediction technique-determiner 604, a prediction mode-determiner 606, and a prediction performer 608.

When the color format of the input video is a YUV format (YUV420, YUV411, YUV422, YUV444, or the like), the video decoding device may perform prediction and reconstruction of the luma component and then may perform prediction and reconstruction of the chroma component. In other words, the luma component and the chroma component may be sequentially reconstructed by the components illustrated in FIG. 6. On the other hand, when the color format of the input video is RGB, the video encoding device may perform a color format transform from RGB to YUV, and then may encode the transformed video. Here, in the case of the YUV format, the color format represents a corresponding relation between pixels in the luma component and pixels in the chroma component.

The prediction unit-determiner 602 determines a prediction unit (PU). The prediction technique-determiner 604, for the prediction unit, determines a prediction technique, e.g., intra prediction, inter prediction, or intra block copy (IBC) mode, palette mode, or the like. The prediction mode-determiner 606 determines a detailed prediction mode for the prediction technique. The prediction performer 608 generates a prediction block of the current block according to the determined prediction mode.

The inverse transformer 530 includes a transform unit-determiner 610 and an inverse transform-performer 612. The transform unit-determiner 610 determines a transform unit (TU) for the inverse quantization signals of the current block, and the inverse transform-performer 612 inversely transforms the transform unit represented by the inverse quantization signals to generate residual signals.

The adder 550 sums the prediction block and the residual signals to generate a reconstructed block. The reconstructed block is stored in memory and may be used for predicting other blocks in the future.

The prediction unit determined by the prediction unit-determiner 602 may become the current block or one subblock of the subblocks split from the current block. In this case, the prediction unit of the chroma component may correspond in size to the prediction unit of the luma component, depending on the color format. Alternatively, the prediction units of the luma component and the chroma component may be determined separately, and the prediction may be performed for the prediction unit of the chroma component.

The prediction technique-determiner 604 determines a prediction technique for the prediction units. As described above, the prediction technique may be one of inter prediction, intra prediction, IBC mode, and palette mode. In this case, the prediction technique of the chroma component may be determined to be the same as the prediction technique of the corresponding luma component without signaling and parsing separate information.

The following describes a case where the prediction technique of the current chroma block is intra prediction, when the prediction mode-determiner 606 determines the prediction mode of the current chroma block, and the prediction performer 608 predicts the current chroma block.

In one example, the prediction mode-determiner 606 may determine an intra prediction mode utilizing the neighboring reconstructed chroma samples of the current chroma block as the prediction mode of the current chroma block. At this time, the prediction performer 608 may generate a prediction block of the current chroma block by using the neighboring reconstructed chroma samples according to the determined intra prediction mode.

In one example, the prediction mode-determiner 606 may determine, based on signaling and parsing of the 1-bit flag, a mode that utilizes a relationship between the neighboring reconstructed chroma samples of the current chroma component and the neighboring reconstructed luma samples of a luma block at a corresponding position (hereinafter, the ‘corresponding luma block’) as the prediction mode of the current chroma block.

At this time, the prediction performer 608 may model the relationship between the neighboring reconstructed chroma samples of the current chroma component and the corresponding luma block's neighboring reconstructed luma samples. The prediction performer 608 may use the modeled relationship to generate a prediction block of the current chroma block.

In one example, the prediction performer 608 may implicitly select the reconstructed luma sample regions and the reconstructed chroma sample regions for performing the modeling based on statistical characteristics between the reconstructed luma sample regions and the reconstructed chroma sample regions. The prediction performer 608 may use the selected regions to model the relationship between the neighboring reconstructed chroma samples and the corresponding luma block's neighboring reconstructed luma samples.

As another example, the video encoding device may signal an index indicating one of the regions, such as the top, the left side, or the top and left side of the current block. The prediction performer 608 may parse the index and select a region to use for modeling for the prediction of the chroma component based on the parsed index. The prediction performer 608 may use the selected region to model the relationship between the neighboring reconstructed chroma samples and the corresponding luma block's neighboring reconstructed luma samples.

Hereinafter, ‘modeling for prediction of chroma components’ may be expressed simply as ‘modeling’.

As another example, the prediction mode-determiner 606 may determine planar, DC, horizontal, vertical modes, or direct mode (DM) as the prediction mode of the current chroma block.

For example, when the prediction according to the DM is performed, the prediction performer 608 may generate the prediction block of the current chroma block by using the same intra-prediction mode as the corresponding luma block.

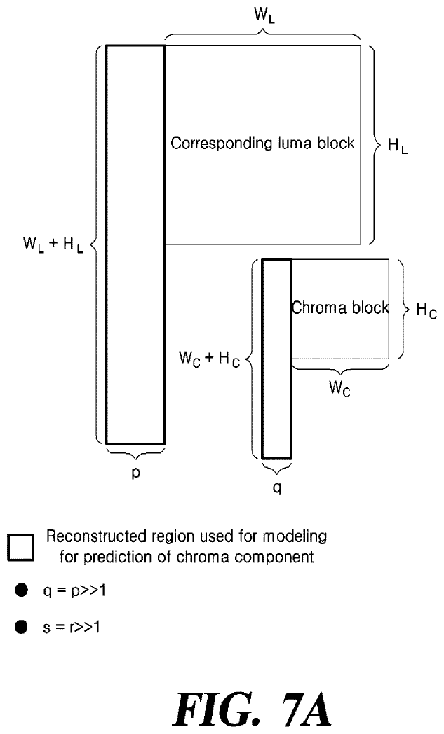

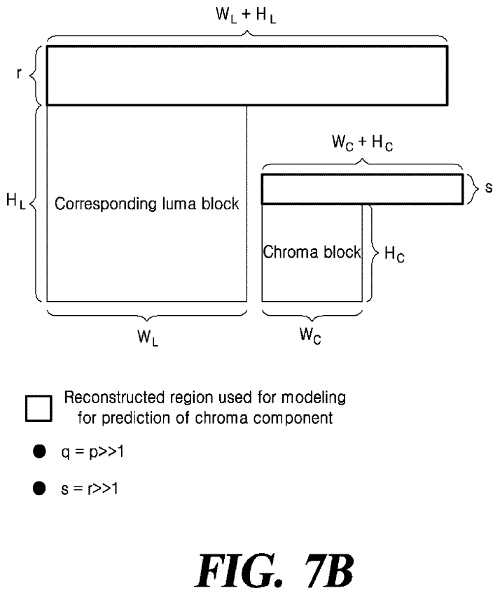

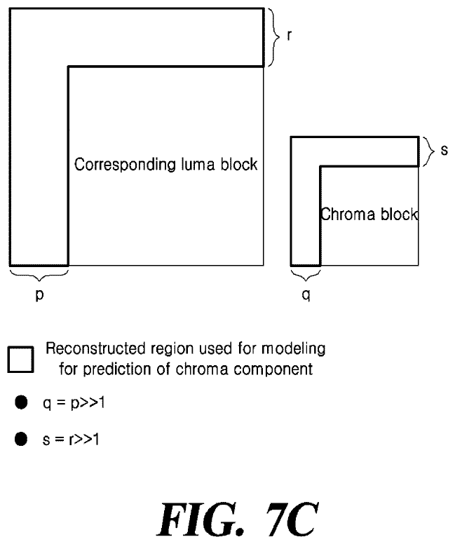

FIGS. 7A to 7C are diagrams illustrating the positions of samples used for modeling, according to at least one embodiment of the present disclosure.

In one example, when the color format of the input video is YUV420 and the relationship is to be modeled between the neighboring reconstructed chroma samples and the corresponding luma block's neighboring reconstructed luma samples, the video decoding device may determine the left of the current block, the top of the current block, or the top and left of the current block as the position of the samples used for modeling for prediction of the chroma component, as illustrated in the examples of FIGS. 7A to 7C.

At this time, the video encoding device may determine an index indicative of the region holding the samples used for modeling and may signal the determined index to the video decoding device. The video decoding device may parse the index, and determine, based on the parsed index, a region holding the samples used for modeling.

As another example, the video decoding device may implicitly determine the position of the region for modeling based on prediction information in the corresponding luma block. Here, the prediction information may include an aspect ratio of the block, a prediction mode of the block, and the like.

In one example, the video decoding device may implicitly determine a position of the region for modeling based on an aspect ratio of the current chroma block having a size W_{C}×H_{C}. For example, if W_{C}<H_{C}, the position of the region for modeling may be determined as shown in FIG. 7A. If W_{C}>H_{C}, the position of the region for modeling may be determined as shown in FIG. 7B. Alternatively, if W_{C}=H_{C}, the position of the region for modeling may be determined as shown in FIG. 7C. Here, the aspect ratio indicates the ratio of the width to the height of the block (width/height). Alternatively, the aspect ratio of the corresponding luma block may be used to implicitly determine the position of the region for modeling.

In the examples of FIGS. 7A to 7C, ‘p’ represents the width of the reconstructed region to the left of the corresponding luma block, and ‘q’ represents the width of the reconstructed region to the left of the current chroma block. Additionally, ‘r’ represents the height of the reconstructed region at the top of the corresponding luma block, and ‘s’ represents the height of the reconstructed region at the top of the current chroma block. In this case, the relationship between ‘p’ and ‘q’ and the relationship between ‘r’ and ‘s’ may be determined according to the color format of the input video. For example, if the color format of the input video is YUV420, q=p>>1, s=r>>1.

Further, the video decoding device may determine, according to the prediction mode of the corresponding luma block, the position of the region holding the samples used for modeling, as follows.

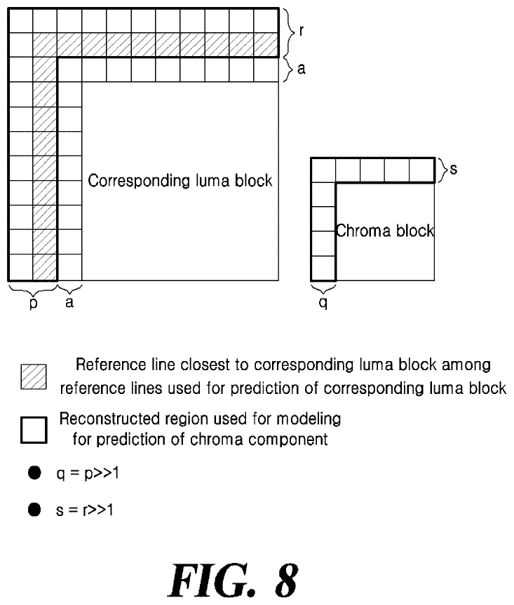

FIG. 8 is a diagram illustrating the derivation of the positions of the samples used for modeling, according to at least one embodiment of the present disclosure.

First, a case is now described where the block partitioning structures of the luma component and the chroma component are the same according to the use of a single tree structure. In a case where a corresponding luma block is not predicted based on the adjacent top-and-left reference line or region during the prediction process, and a corresponding luma block is predicted based on a non-adjacent reference line or non-adjacent reference region distant by ‘a’ (a natural number), as illustrated in FIG. 8, the video decoding device may set the reconstructed region of the luma component, holding the samples for modeling (hereinafter, the ‘reconstructed region of the luma component’ omitting the ‘holding the samples for modeling’ part) by a region constructed from the line used for prediction, as illustrated in FIG. 8. In this case, the reconstructed region of the chroma component, holding the samples for modeling (hereinafter, the ‘reconstructed region of the chroma component’) may be a region adjacent to the current chroma block, as illustrated in FIG. 8. In the example of FIG. 8, the relationship between ‘p’ and ‘q’, and the relationship between ‘r’ and ‘r’ may be determined based on the color format of the input video.

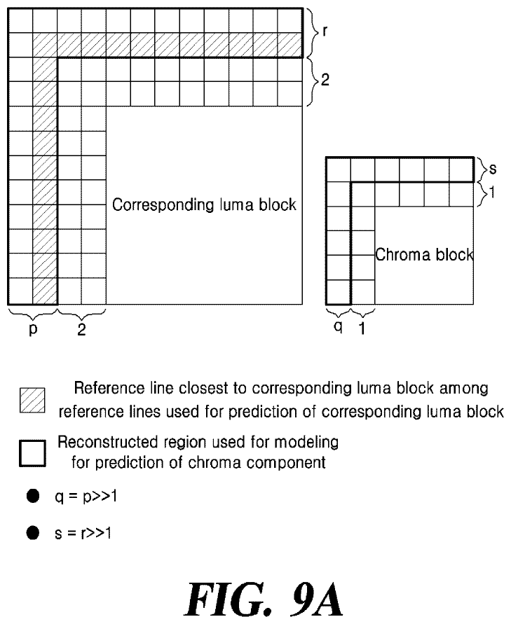

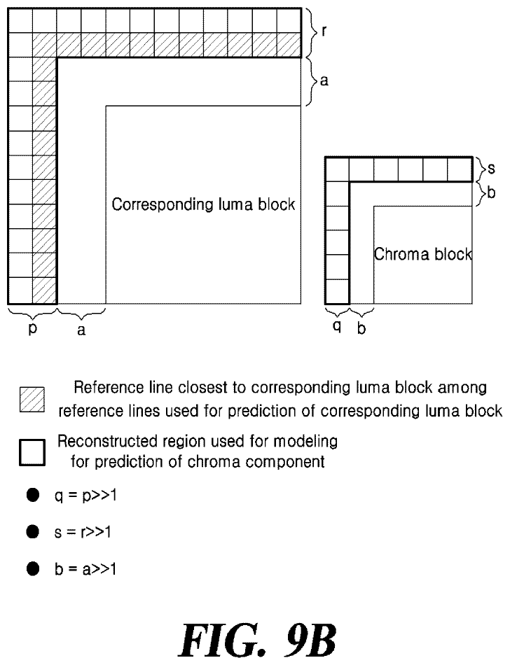

FIGS. 9A and 9B are diagrams illustrating derivations of the positions of samples used for modeling, according to other embodiments of the present disclosure.

As another example, depending on the distance between the corresponding luma block and the reference line used for prediction of the corresponding luma block, the video decoding device may perform modeling by using a reconstructed non-adjacent region of the chroma component, as illustrated in FIG. 9A. In this case, a reference region for modeling may be determined based on the color format of the input video. For example, as illustrated in FIG. 9B, if the distance between the reconstructed luma region and the corresponding luma block is ‘a’, concerning the luma component, the reference region for modeling may be implicitly determined to be a region distant from the luma block by ‘a’. Further, concerning the chroma component, the reference region for modeling may be implicitly determined to be a region distant from the chroma block by ‘b’ which is a natural number.

Meanwhile, in the examples of FIGS. 9A and 9B, the definitions of p, q, r, and s are the same as in the example of FIG. 7C. Further, ‘a’ represents the distance between the corresponding luma block and the reconstructed region, and ‘b’ represents the distance between the current chroma block and the reconstructed region. In this case, the relationship between ‘p’ and ‘q’, the relationship between ‘r’ and ‘s’, and the relationship between ‘a’ and ‘b’ may be determined according to the color format of the input video.

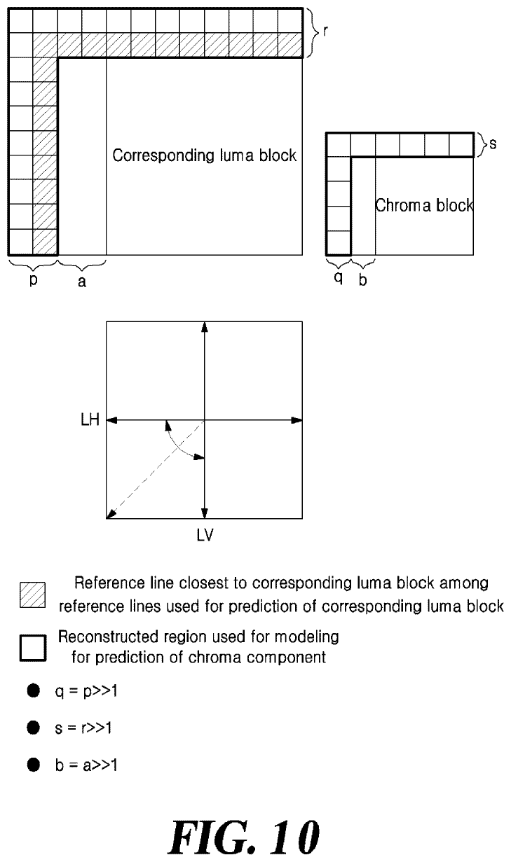

As yet another example, as illustrated in FIG. 10, a case is now described where a reference line used for the prediction of a corresponding luma block is non-adjacent to the luma block, the luma block is predicted according to a directional prediction, and the direction of the intra-prediction mode is between the LH direction and the LV direction (i.e., a preset left-down direction). At this time, the reconstructed regions of the luma component and the chroma component may be implicitly determined to be only partially non-adjacent to the current block, such as in the example of FIG. 10.

On the other hand, in the example of FIG. 10, the definition of p, q, r, s, a, and b is the same as in the example of FIG. 7C. In this case, the relationship between ‘p’ and ‘q’, the relationship between ‘r’ and ‘s’, and the relationship between ‘a’ and ‘b’ may be determined according to the color format of the input video.

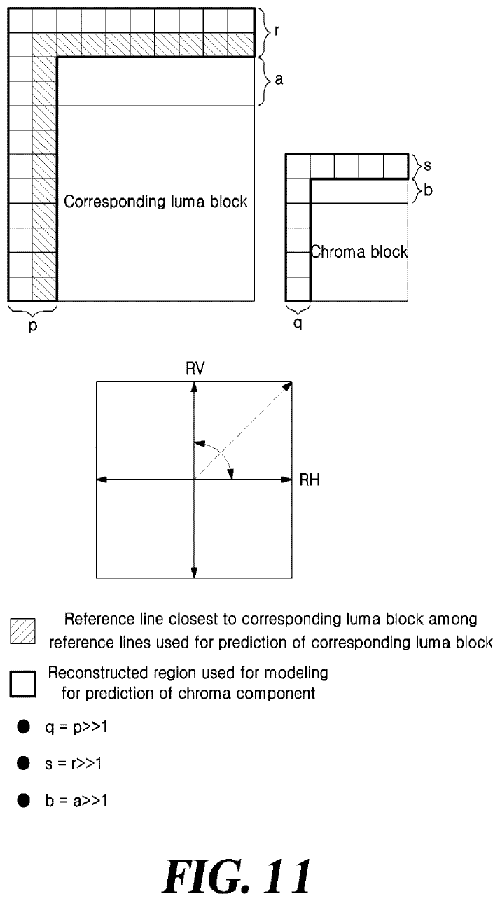

As another example shown in FIG. 11, a case is now described where the reference line used for prediction of the corresponding luma block is non-adjacent to the luma block, the luma block is predicted according to a directional prediction, and the direction of the intra prediction mode is between the RV direction and the RH direction (i.e., a preset right upward direction). At this time, the reconstructed regions of the luma component and the chroma component may be implicitly determined to be only partially non-adjacent to the current block, such as in the example of FIG. 11.

On the other hand, in the example of FIG. 11, the definition of p, q, r, s, a, and b is the same as in the example of FIG. 7C. In this case, the relationship between ‘p’ and ‘q’, the relationship between ‘r’ and ‘s’, and the relationship between ‘a’ and ‘b’ may be determined according to the color format of the input video.

Next, a case is now described where the dual tree structure is used resulting in a difference between the block partitioning structure of the luma component and the block partitioning structure of the chroma component, such that the luma region at the corresponding position to the current chroma block (hereinafter, the ‘corresponding luma region’) is predicted as a plurality of blocks. At this time, the video decoding device may determine a reconstructed region holding samples to be used for modeling according to the prediction mode of the blocks including the top-and-left boundary of the corresponding luma region.

Meanwhile, when a dual tree structure is used, the video decoding device may express a corresponding luma block by a corresponding luma region, and a luma block within the corresponding luma region may be represented by a sub-luma block.

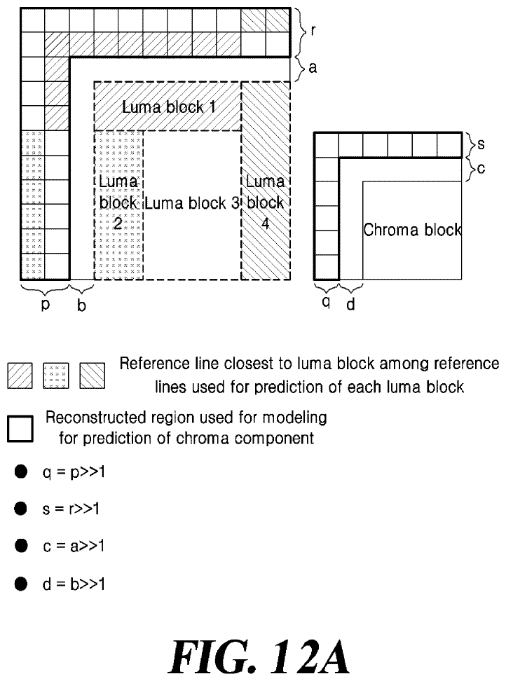

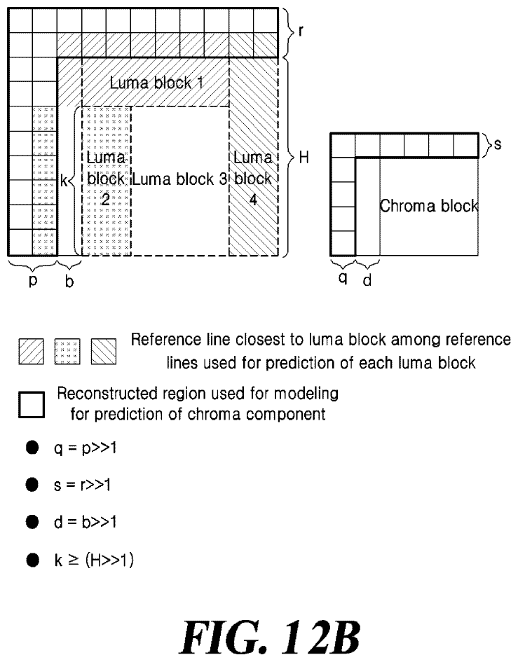

FIGS. 12A and 12B are diagrams illustrating implicit derivation of the positions of samples used for modeling, according to other embodiments of the present disclosure.

For example, a case is now described where the blocks, adjacent to the top boundary of the corresponding luma region having a size W×H (W is the width of the region and H is the height of the region), hold luma blocks predicted by using the non-adjacent reference line, and where those blocks have an area that is adjacent to the top boundary of the corresponding luma block and assumes a predetermined (e.g., ‘W>>1’) or more of the width of the corresponding luma block. Further, the case is also conditioned that the blocks adjacent to the left boundary of the corresponding luma region hold luma blocks predicted by using the non-adjacent reference line and that those luma blocks have an area that is adjacent to the left boundary of the corresponding luma block and assumes a predetermined (e.g., ‘H>>1’) or more of the height of the corresponding luma block. The reconstructed region of the luma component may be implicitly determined as a region distant from the corresponding luma region by ‘a’ and ‘b’ (where ‘a’ and ‘b’ are 0 or a natural number), as illustrated in FIG. 12A. Further, the reconstructed region of the chroma component may be implicitly determined as a region distant from the chroma block by ‘c’ and ‘d’. Here, ‘a’ may be the distance to the line closest to the corresponding luma block among the non-adjacent reference lines used in the prediction process of the blocks adjacent to the top of the corresponding luma region, and ‘b’ may be the distance to the line closest to the luma block among the non-adjacent reference lines used in the prediction process of the blocks adjacent to the left of the corresponding luma region.

Further, when ‘a’ or ‘b’ is zero, the top or left region holding the samples for modeling may be a region constructed from adjacent reference lines, rather than a region constructed from non-adjacent reference lines, as in the example of FIG. 12B. In the example of FIG. 12B, ‘a’ is 0. In the example of FIG. 12B, a luma block 2 predicted by using the non-adjacent reference line may use the non-adjacent reference line because a region ‘k’ adjacent to the left boundary of the corresponding luma region is ‘H>>1’ or more.

Meanwhile, in the examples of FIGS. 12A and 12B, the definitions of p, q, r, and s are the same as in the example of FIG. 7C. Further, ‘a’ indicates the closest distance between the corresponding luma region and the top reconstructed region, and ‘c’ indicates the distance between the current chroma block and the top reconstructed region. ‘b’ represents the closest distance between the corresponding luma region and the left reconstructed region, and ‘d’ represents the distance between the current chroma block and the left reconstructed region. At this time, the relationship between ‘p’ and ‘q’, the relationship between ‘r’ and ‘s’, the relationship between ‘a’ and ‘c’, and the relationship between ‘b’ and ‘d’ may be determined according to the color format of the input video.

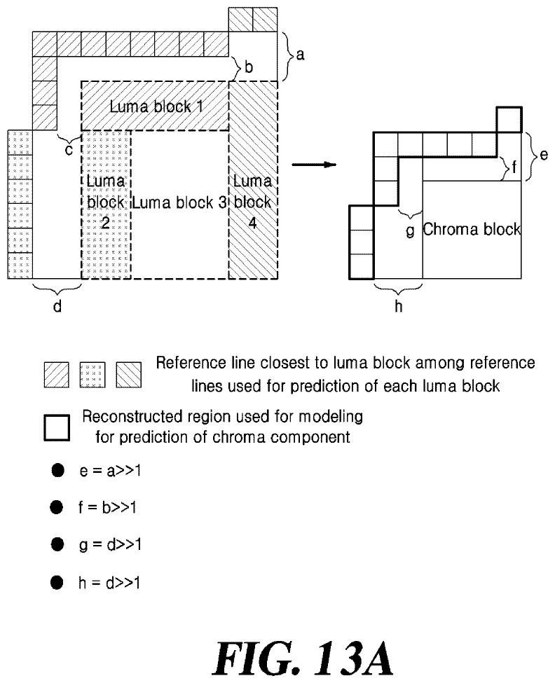

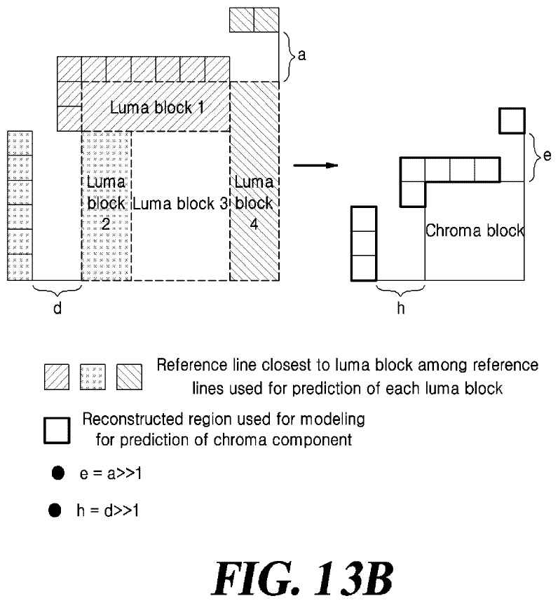

FIGS. 13A and 13B are diagrams illustrating implicit derivation of the positions of samples used for modeling, according to other embodiments of the present disclosure.

As another example, a case is now described where the blocks, adjacent to the top-and-left boundary of a corresponding luma region having dimensions W×H, hold both luma blocks predicted by using non-adjacent reference lines and luma blocks predicted by using adjacent reference lines. The reconstructed region of the luma component may be implicitly determined to be a non-adjacent region with respect to a region holding the blocks predicted by using the non-adjacent reference line and implicitly determined to be an adjacent region with respect to a region holding the blocks predicted by using the adjacent reference line, as illustrated in FIGS. 13A and 13B. Further, regarding the region determined in the luma component, the reconstructed region in the chroma component may be determined to be at a corresponding position according to the color format.

In the example of FIG. 13A, there are no luma blocks predicted by using the adjacent reference lines. Therefore, the reconstructed region of the luma component is determined to be a non-adjacent region for the region with blocks predicted by using the non-adjacent reference lines. On the other hand, if a, b, c, and/or d are/is zero, there may be luma blocks predicted by using adjacent reference lines. In this case, the top or left region holding the samples for modeling may include adjacent regions for the blocks predicted by using the adjacent reference lines, as illustrated in FIG. 13B. In the example of FIG. 13B, ‘b’ and ‘c’ are zero.

Meanwhile, in the example of FIGS. 13A and 13B, a, b, c, and d represent distances between a corresponding luma region and a reconstructed region, and e, f, g, and h, corresponding to a, b, c, and d, respectively, represent distances between a current chroma block and the reconstructed region. At this time, the relationship between ‘a’ and ‘e’, the relationship between ‘b’ and ‘f’, the relationship between ‘c’ and ‘g’, and the relationship between ‘d’ and ‘h’ may be determined according to the color format of the input video.

On the other hand, if the reconstructed regions of the luma component and the reconstructed regions of the chroma component holding the samples to be used for modeling are determined, the video decoding device may use the samples in the determined reconstructed regions of each component to derive parameters a and R representing a linear relationship between the components.

In one example, the video decoding device may utilize all of the samples within the region of each component to derive the parameters. For example, after the samples in the reconstructed region of the luma component are sorted in descending order, and the samples in the reconstructed region of the chroma component are sorted in descending order, the video decoding device may calculate, for each of the components, Lₘ₋ₘₐₓ, Lₘ₋ₘᵢₙ, Cₘ₋ₘₐₓ, and Cₘ₋ₘᵢₙ which are the average of the maximum value and the second largest value, and the average of the minimum value and the second smallest value. The video decoding device may then derive α and β as shown in Equation 3.

$$α = \frac{{L}_{m - max} - {L}_{m - min}}{{C}_{m - max} - {C}_{m - min}} , \qquad [ Equation 3 ]$$

$$β = {L}_{m - min} - α \cdot {C}_{m - min}$$

As another example, the video decoding device may derive the parameters by using only those samples, within the region of each component, corresponding to a predetermined position based on the block size. For example, after sorting in descending order the samples at the predetermined position in the reconstructed region of the luma component, and sorting in descending order the samples at the predetermined position in the reconstructed region of the chroma component, the video decoding device may calculate, for each of the components, Lₘ₋ₘₐₓ, Lₘ₋ₘᵢₙ, Cₘ₋ₘₐₓ, and Cₘ₋ₘᵢₙ which are the average of the maximum and the second largest value, and the average of the minimum and the second smallest value. The video decoding device may then derive α and β as shown in Equation 3.

The video decoding device may then use the calculated parameters to calculate a prediction sample of the chroma component, Pred_{chroma}, as shown in Equation 4.

$${Pred}_{Chroma} = α \cdot {Rec}_{Luma}^{′} + β \qquad [ Equation 4 ]$$

Here, Rec′_{Luma} may be a sample value in a corresponding luma block or a sample value in a downsampled corresponding luma block.

As described above, the video decoding device may derive a and R, and then may generate a prediction block of the current chroma block according to Equation 4. Further, the video decoding device may correct the derived a and R, respectively, and apply the corrected a and R to Equation 4 to generate the prediction block of the current chroma block.

As another example, rather than using a single equation, the video decoding device may separate the equation into a plurality of linear equations, may derive a and R for each of the linear equations and may use the derived parameters to generate a prediction block of the current chroma block.

Hereinafter, a case is described where the prediction mode of the current chroma block is determined to be planar, DC, horizontal, vertical modes, DM, or a mode utilizing a neighboring reference region of the current chroma block. The video decoding device may implicitly set a position of the reference line for the prediction of the current chroma block based on the prediction mode of the corresponding luma block.

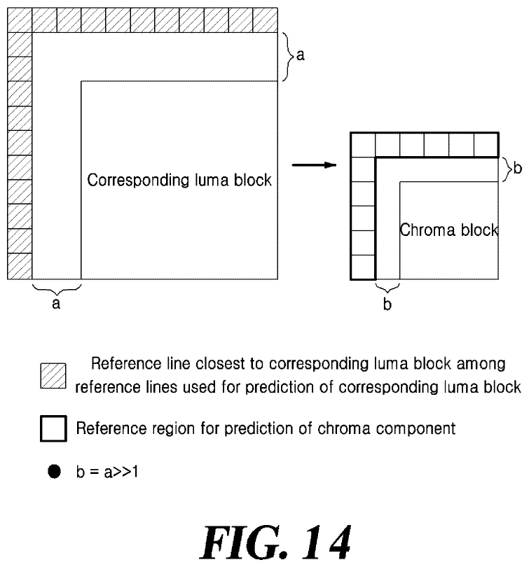

FIG. 14 is a diagram illustrating the derivation of a reconstructed reference line or region of a chroma component, according to at least one embodiment of the present disclosure.

First, a case is described where, according to the use of a single tree structure, the luma component and the chroma component have the same block partitioning structure. In the case where, during the prediction process, the corresponding luma block is predicted as in the example of FIG. 14, not based on the adjacent top-and-left reference line or region but based on a non-adjacent reference line or non-adjacent reference region, the video decoding device may set the reconstructed reference line or region of the chroma component with the non-adjacent reference line or region of the current chroma block, as in the example of FIG. 14. In the example of FIG. 14, ‘a’ (a natural number) indicates a distance between the corresponding luma block and the reconstructed region, and ‘b’ indicates a distance between the current chroma block and the reconstructed region. In this case, the relationship between ‘a’ and ‘b’ may be determined based on the color format of the input video.

Next, a case is described where, according to the use of a dual tree structure, the luma component and the chroma component have different block partitioning structures, such that the corresponding luma region to the current chroma block is predicted as a plurality of blocks. At this time, the video decoding device may determine the reconstructed reference line or region of the chroma component according to the prediction mode of the blocks including the top-and-left boundary of the corresponding luma region as follows.

On the other hand, when a dual tree structure is used, a corresponding luma block may be represented by a corresponding luma region, and a luma block within the corresponding luma region may be represented by a sub-luma block.

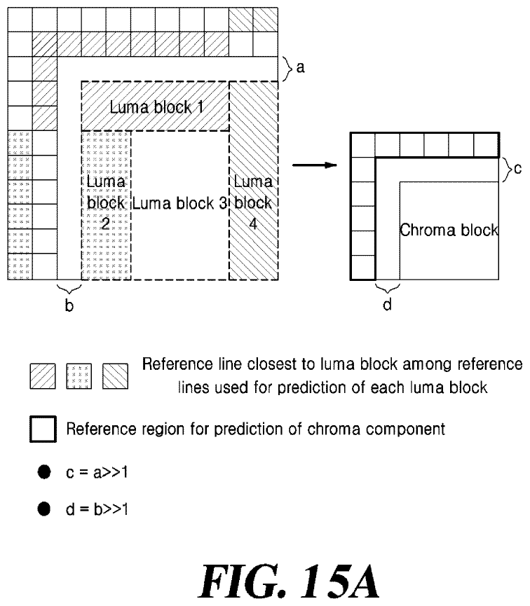

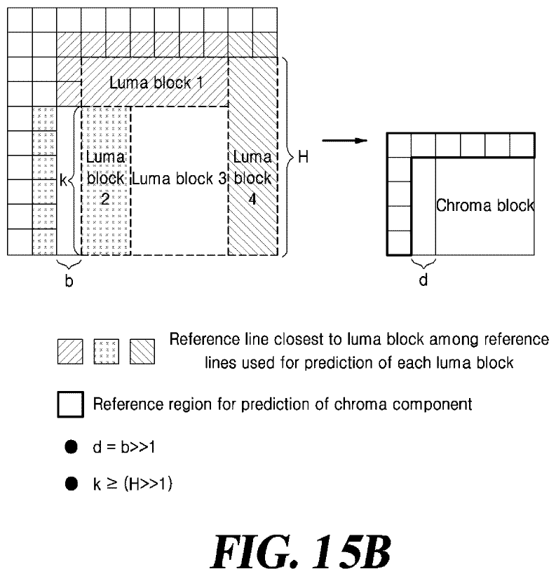

FIGS. 15A and 15B are diagrams illustrating the implicit derivation of reconstructed reference lines or regions of chroma components, according to at least one embodiment of the present disclosure.

In an example case, the blocks, adjacent to a top boundary of the corresponding luma region having a size W×H, hold luma blocks predicted by using a non-adjacent reference line, and the luma blocks have an area that is adjacent to the top boundary of the luma block and assumes a predetermined ratio (e.g., ‘W>>1’) or more of a width of the corresponding luma block. The case is also conditioned that the blocks, adjacent to a left boundary of the luma block, hold luma blocks predicted by using a non-adjacent reference line, and luma blocks have an area that is adjacent to the left boundary of the luma block and assumes a predetermined ratio (e.g., ‘H>>1’) or more of a height of the corresponding luma block. The reconstructed reference line or region of the chroma component may be implicitly determined as a line or region distant from the chroma block by ‘c’ and ‘d’, as illustrated in FIG. 15A. Here, ‘c’ may be determined based on the distance ‘a’ (0 or a natural number) to a line closest to the corresponding luma region among the non-adjacent reference lines used in the prediction process of the blocks adjacent to the top boundary of the corresponding luma region, and ‘d’ may be determined based on the distance ‘b’ (0 or a natural number) to the line closest to the corresponding luma region among the non-adjacent reference lines used in the prediction process of the blocks adjacent to the left boundary of the corresponding luma region.

Further, when ‘a’ or ‘b’ is 0, the reconstructed reference line or region of the chroma component may be a region constructed from the adjacent reference line or region, rather than a region constructed from the non-adjacent reference line or region, as in the example of FIG. 15B. In the example of FIG. 15B, ‘a’ is 0. In the example of FIG. 15B, the luma block 2 predicted by using the non-adjacent reference line may use the non-adjacent reference line because the region k adjacent to the left boundary of the corresponding luma region is ‘H>>1’ or more.

In the example of FIGS. 15A and 15B, ‘a’ represents the closest distance between the corresponding luma region and the top reconstructed region, and ‘c’ represents the distance between the current chroma block and the top reconstructed region. ‘b’ represents the closest distance between the corresponding luma region and the left reconstructed region, and ‘d’ represents the distance between the current chroma block and the left reconstructed region. In this case, the relationship between ‘a’ and ‘c’, and the relationship between ‘b’ and ‘d’ may be determined according to the color format of the input video.

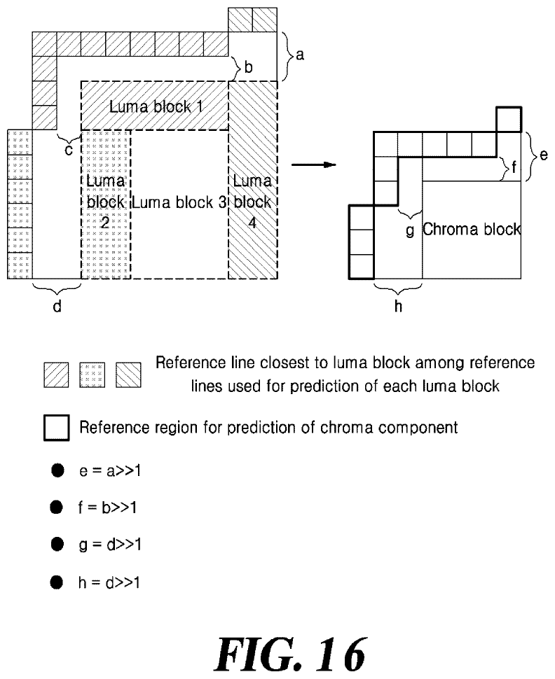

FIG. 16 is a diagram illustrating the implicit derivation of a reconstructed reference line or region of a chroma component, according to another embodiment of the present disclosure.

As another example, a case is described where there are both luma blocks predicted by using non-adjacent reference lines and luma blocks predicted by using adjacent reference lines for luma blocks adjacent to the top-and-left boundary of a corresponding luma region having size W×H. Among the corresponding luma regions, the video decoding device may correspond the non-adjacent region to a chroma block for the region holding the blocks predicted by using the non-adjacent reference line, and correspond the adjacent region to a chroma block for the region holding the blocks predicted by using the adjacent reference line. Accordingly, the reconstructed reference lines or regions of the chroma component may be implicitly determined as illustrated in FIG. 16.

In the example of FIG. 16, there are no luma blocks predicted by using the adjacent reference line. Therefore, the reconstructed reference lines or regions of the chroma component are determined to correspond to the non-adjacent regions with the regions holding the blocks predicted by using the non-adjacent reference lines. On the other hand, if a, b, c, and/or d are/is 0, there may be luma blocks predicted by using the adjacent reference line. In this case, the reconstructed reference line or region of the chroma component may be determined to correspond to the adjacent region with respect to the blocks predicted by using the adjacent reference line.

Meanwhile, in the example of FIG. 16, a, b, c, and d represent distances between a corresponding luma region and a reconstructed region, and e, f, g, and h correspond to a, b, c, and d, respectively, and represent distances between the current chroma block and the reconstructed region. The relationship between ‘a’ and ‘e’, the relationship between ‘b’ and ‘f’, the relationship between ‘c’ and ‘g’, and the relationship between ‘d’ and ‘h’ may be determined according to the color format of the input video.

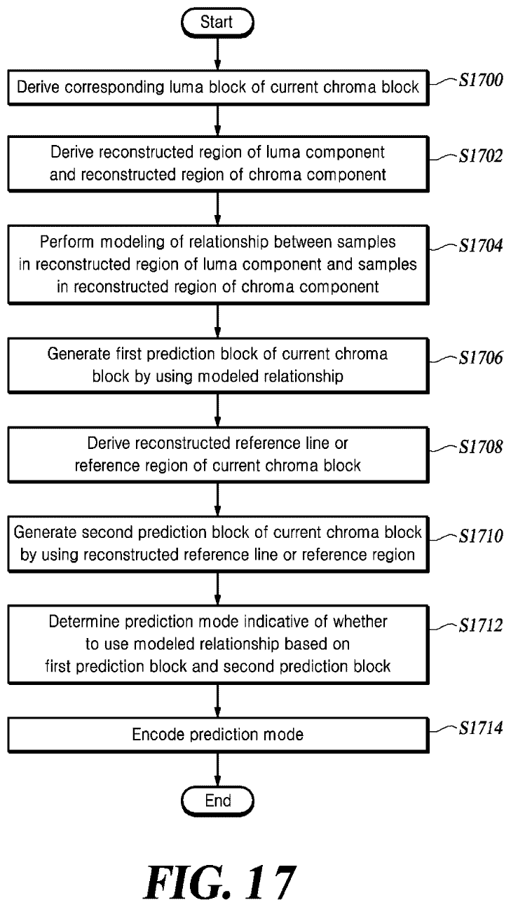

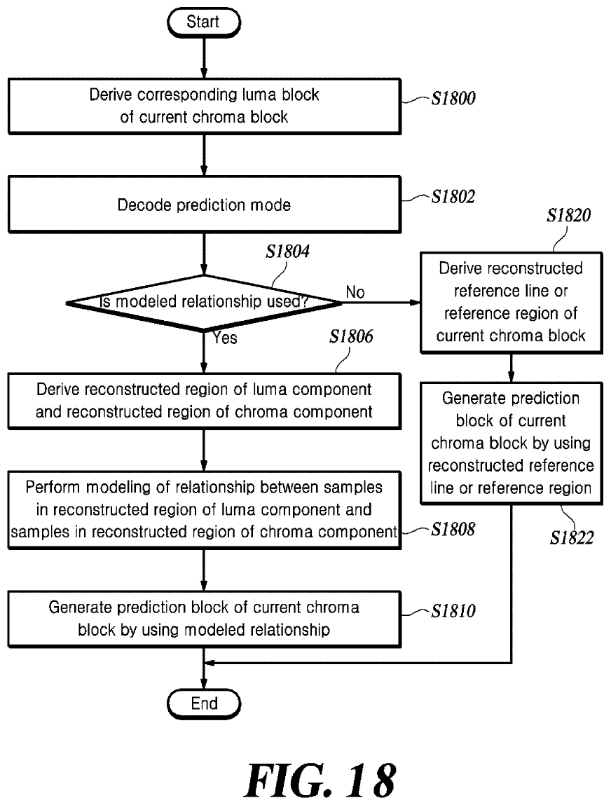

Referring now to FIGS. 17 and 18, methods for encoding and decoding a chroma block are described.

FIG. 17 is a flowchart of a method of intra predicting the current block performed by a video encoding device, according to at least one embodiment of the present disclosure.

The video encoding device derives a corresponding luma block of the current chroma block based on a color format (S1700). Here, the color format indicates a corresponding relation between pixels in the corresponding luma block and pixels in the current chroma block. Furthermore, it is assumed that the luma component is decoded before the decoding of the current chroma block according to the decoding order of the decoder side in the video encoding device.

Based on the block partitioning structure of the luma component and the chroma component, and the prediction information of the corresponding luma block, the video encoding device derives a reconstructed region of the luma component for the corresponding luma block and derives a reconstructed region of the chroma component for the current chroma block (S1702). Here, the prediction information may include an aspect ratio of the block, a prediction mode of the block, and the like.

The video encoding device models a relationship between the samples in the reconstructed region of the luma component and the samples in the reconstructed region of the chroma component (S1704).

The video encoding device generates a first prediction block of the current chroma block from the samples in the corresponding luma block by using the modeled relationship (S1706).

The video encoding device derives a reconstructed reference line or reference region of the current chroma block based on the block partitioning structure and the predicted information of the corresponding luma block (S1708).

The video encoding device generates a second prediction block of the current chroma block by using the reconstructed reference line or reference region (S1710).

Based on the first prediction block and the second prediction block, the video encoding device determines a prediction mode indicative of whether to use the modeled relationship (S1712).

In terms of rate-distortion optimization, the video encoding device may determine the prediction mode for intra prediction of the current block. For example, if the first prediction block is optimal, the video encoding device may select a prediction mode that utilizes the modeled relationship. On the other hand, if the second prediction block is optimal, the video encoding device selects a prediction mode that does not use the modeled relationship. The prediction mode that does not use the modeled relationship may include planar, DC, horizontal, vertical modes, DM, or a mode that performs the prediction by using a neighboring reference region of the current chroma block.

The video encoding device encodes the prediction mode (S1714).

FIG. 18 is a flowchart of a method of intra predicting the current block performed by a video decoding device, according to at least one embodiment of the present disclosure.

The video decoding device derives a corresponding luma block of the current chroma block based on a color format (S1800). Here, the color format indicates a corresponding relation between the pixels of the corresponding luma block and the pixels of the current chroma block. Furthermore, it is assumed that the luma component is decoded before the decoding of the current chroma block according to the decoding order.

The video decoding device decodes the prediction mode of the current chroma block from the bitstream (S1802).

The video decoding device determines whether the prediction mode utilizes a modeled relationship (S1804). Here, the modeled relationship represents a relationship between samples in a reconstructed region of the luma component and samples in a reconstructed region of the chroma component.

If the prediction mode utilizes the modeled relationship (Yes in S1804), the video decoding device performs the following steps (S1806 to S1810).

Based on the block partitioning structure of the luma component and the chroma component, and the prediction information of the corresponding luma block, the video decoding device derives a reconstructed region of the luma component for the corresponding luma block, and a reconstructed region of the chroma component for the current chroma block (S1806). Here, the prediction information may include an aspect ratio of the block, a prediction mode of the block, and the like.

The video decoding device models a relationship between the samples in the reconstructed region of the luma component and the samples in the reconstructed region of the chroma component (S1808).

The video decoding device uses the modeled relationship to generate a prediction block of the current chroma block from the samples in the corresponding luma block (S1810).

On the other hand, if the prediction mode does not utilize the modeled relationship (No in S1804), the video decoding device performs the following steps (S1820 to S1822). Here, the prediction mode that does not use the modeled relationship may include planar, DC, horizontal, vertical modes, direct mode (DM), or a mode that performs the prediction by using a neighboring reference region of the current chroma block.

The video decoding device derives a reconstructed reference line or reference region of the current chroma block based on the block partitioning structure and the prediction information of the corresponding luma block (S1820).

The video decoding device generates a prediction block of the current chroma block by using the reconstructed reference line or reference region according to the prediction mode (S1822).

Although the steps in the respective flowcharts are described to be sequentially performed, the steps merely instantiate the technical idea of some embodiments of the present disclosure. Therefore, a person having ordinary skill in the art to which this disclosure pertains could perform the steps by changing the sequences described in the respective drawings or by performing two or more of the steps in parallel. Hence, the steps in the respective flowcharts are not limited to the illustrated chronological sequences.

It should be understood that the above description presents illustrative embodiments that may be implemented in various other manners. The functions described in some embodiments may be realized by hardware, software, firmware, and/or their combination. It should also be understood that the functional components described in the present disclosure are labeled by “ . . . unit” to strongly emphasize the possibility of their independent realization.

Meanwhile, various methods or functions described in some embodiments may be implemented as instructions stored in a non-transitory recording medium that can be read and executed by one or more processors. The non-transitory recording medium may include, for example, various types of recording devices in which data is stored in a form readable by a computer system. For example, the non-transitory recording medium may include storage media, such as erasable programmable read-only memory (EPROM), flash drive, optical drive, magnetic hard drive, and solid state drive (SSD) among others.

Although embodiments of the present disclosure have been described for illustrative purposes, those having ordinary skill in the art to which this disclosure pertains should appreciate that various modifications, additions, and substitutions are possible, without departing from the idea and scope of the present disclosure. Therefore, embodiments of the present disclosure have been described for the sake of brevity and clarity. The scope of the technical idea of the embodiments of the present disclosure is not limited by the illustrations. Accordingly, those having ordinary skill in the art to which the present disclosure pertains should understand that the scope of the present disclosure should not be limited by the above explicitly described embodiments but by the claims and equivalents thereof.

### REFERENCE NUMERALS

122: intra predictor
542: intra predictor
602: prediction unit-determiner
604: prediction technique-determiner
606: prediction mode-determiner
608: prediction performer

### CROSS-REFERENCE TO RELATED APPLICATIONS

This application claims priority to and the benefit of Korean Patent Application No. 10-2022-0099336 filed on Aug. 9, 2022, and Korean Patent Application No. 10-2023-0082623, filed on Jun. 27, 2023, the entire contents of each of which are incorporated herein by reference.

What is claimed is:

1. A method performed by a video decoding device for intra predicting a current chroma block, the method comprising:
deriving a corresponding luma block that corresponds to the current chroma block based on a color format that represents a corresponding relation between pixels of the corresponding luma block and pixels of the current chroma block;
deriving a reconstructed region of a luma component for the corresponding luma block and deriving a reconstructed region of a chroma component for the current chroma block based on a block partitioning structure of the luma component and the chroma component and prediction information of the corresponding luma block;
modeling a relationship between samples in the reconstructed region of the luma component and samples in the reconstructed region of the chroma component; and
generating a prediction block of the current chroma block from samples in the corresponding luma block by using a modeled relationship.

2. The method of claim 1, further comprising:
decoding a prediction mode of the current chroma block from a bitstream; and
determining whether the prediction mode utilizes the modeled relationship,
wherein, when the prediction mode utilizes the modeled relationship, proceeding with deriving the reconstructed region through generating the prediction block.

3. The method of claim 2, further comprising, when the prediction mode does not utilize the modeled relationship:
deriving a reconstructed reference line or reference region of the current chroma block based on the block partitioning structure and the prediction information of the corresponding luma block; and
generating a prediction block of the current chroma block by using the reconstructed reference line or reference region according to the prediction mode.

4. The method of claim 1, wherein deriving the reconstructed region comprises:
determining, based on an aspect ratio of the corresponding luma block, the reconstructed region of the luma component by a left reconstructed region of the corresponding luma block, a top reconstructed region of the corresponding luma block, or a top-and-left reconstructed region of the corresponding luma block.

5. The method of claim 4, wherein deriving the reconstructed region comprises:
determining the reconstructed region of the chroma component as a region corresponding to the reconstructed region of the luma component according to the color format.

6. The method of claim 1, wherein deriving the reconstructed region comprises:
when the block partitioning structure is a single tree structure, and when the corresponding luma block is predicted based on a non-adjacent reference line or non-adjacent reference region distant from the corresponding luma block by a natural number ‘a’, constructing the reconstructed region of the luma component from the non-adjacent reference line or non-adjacent reference region.

7. The method of claim 6, wherein deriving the reconstructed region comprises:
constructing the reconstructed region of the chroma component as a region adjacent to the current chroma block.

8. The method of claim 1, wherein deriving the reconstructed region comprises:
when the block partitioning structure of a single tree structure, using a reconstructed non-adjacent region based on a distance between the corresponding luma block and a reference line used for prediction of the corresponding luma block.

9. The method of claim 8, wherein deriving the reconstructed region comprises:
when the corresponding luma block is predicted based on a non-adjacent reference line distant from the corresponding luma block by a natural number ‘a’, constructing the reconstructed region of the luma component as a region distant from the corresponding luma block by the natural number ‘a’ and constructing the reconstructed region of the chroma component as a region distant from the current chroma block by a natural number ‘b’, wherein the natural number ‘a’ and the natural number ‘b’ have a relationship that is determined according to the color format.

10. The method of claim 1, wherein deriving the reconstructed region comprises:
determining a portion of reconstructed regions of the luma component and the chroma component by a region non-adjacent with the corresponding luma region and the current chroma block when the block partitioning structure is a single tree structure, a reference line used for prediction of the corresponding luma block is non-adjacent with the corresponding luma block, the corresponding luma block is predicted according to a directional prediction, and a prediction mode of the directional prediction is a preset direction.

11. The method of claim 1, wherein deriving the reconstructed region comprises:
determining the reconstructed region of the luma component by a region distant from the corresponding luma block by a natural number ‘a’ and a natural number ‘b’ under a condition that the block partitioning structure is a dual tree structure, blocks adjacent to a top boundary of the corresponding luma block hold sub-luma blocks predicted by using a non-adjacent reference line, the sub-luma blocks have an area that is adjacent to the top boundary of the corresponding luma block and assumes a predetermined ratio or more of a width of the corresponding luma block, and that blocks adjacent to a left boundary of the corresponding luma block hold sub-luma blocks predicted by using a non-adjacent reference line, the sub-luma blocks have an area that is adjacent to the left boundary of the corresponding luma block and assumes a predetermined ratio or more of a height of the corresponding luma block,
wherein the natural number ‘a’ is a distance to a reference line closest to the corresponding luma block among non-adjacent reference lines used for prediction of blocks adjacent to the top boundary, and the natural number ‘b’ is a distance to a reference line closest to the corresponding luma block among non-adjacent reference lines used for prediction of blocks adjacent to the left boundary.

12. The method of claim 11, wherein deriving the reconstructed region comprises:
constructing the reconstructed region of the chroma component as a region distant from the current chroma block by a natural number ‘c’ and a natural number ‘d’, wherein the natural number ‘a’ and the natural number ‘c’ have a relationship that is determined according to the color format and the natural number ‘b’ and the natural number ‘d’ have a relationship that is determined according to the color format.

13. The method of claim 1, wherein deriving the reconstructed region comprises:
determining the reconstructed region of the luma component as a non-adjacent region for a region with sub-luma blocks predicted by using a non-adjacent reference line, and determining the reconstructed region of the luma component as an adjacent region for a region with sub-luma blocks predicted by using a adjacent reference line when the block partitioning structure is a dual tree structure and when blocks adjacent to a top-and-left boundary of the corresponding luma block hold both the sub-luma blocks predicted by using the non-adjacent reference line and the sub-luma blocks predicted by using the adjacent reference line.

14. A method performed by a video encoding device for intra predicting a current chroma block, the method comprising:
deriving a corresponding luma block that corresponds to the current chroma block based on a color format that represents a corresponding relation between pixels of the corresponding luma block and pixels of the current chroma block;
deriving a reconstructed region of a luma component for the corresponding luma block and deriving a reconstructed region of a chroma component for the current chroma block based on a block partitioning structure of the luma component and the chroma component and prediction information of the corresponding luma block;
modeling a relationship between samples in the reconstructed region of the luma component and samples in the reconstructed region of the chroma component; and
generating a first prediction block of the current chroma block from samples in the corresponding luma block by using a modeled relationship.

15. The method of claim 14, further comprising:
deriving a reconstructed reference line or reference region of the current chroma block based on the block partitioning structure and the prediction information of the corresponding luma block; and
generating a second prediction block of the current chroma block by using the reconstructed reference line or the reference region.

16. The method of claim 15, further comprising:
determining, based on the first prediction block and the second prediction block, a prediction mode indicative of whether to use the modeled relationship; and
encoding the prediction mode.

17. A computer-readable recording medium storing a bitstream generated by a video encoding method, the video encoding method comprises:
deriving a corresponding luma block that corresponds to a current chroma block based on a color format that represents a corresponding relation between pixels of the corresponding luma block and pixels of the current chroma block;
deriving a reconstructed region of a luma component for the corresponding luma block and deriving a reconstructed region of a chroma component for the current chroma block based on a block partitioning structure of the luma component and the chroma component and prediction information of the corresponding luma block;
modeling a relationship between samples in the reconstructed region of the luma component and samples in the reconstructed region of the chroma component; and
generating a prediction block of the current chroma block from samples in the corresponding luma block by using a modeled relationship.
